(19) United States
(12) Patent Application Publication
(10) Pub. No.: US 2004/0009284 A1
(43) Pub. Date: Jan. 15, 2004

(54) Foods and drinks containing diacylglycerol

(75) Inventors: Brooke Boice, Decatur, IL (US); Russ Egbert, Decatur, IL (US); Dawn M. Sikorski, Monticello, IL (US); Yvonne M. Stuchell, Decatur, IL (US); Neil Widlak, Decatur, IL (US)

Correspondence Address: STERNE, KESSLER, GOLDSTEIN & FOX PLLC, 1100 NEW YORK AVENUE, N.W., WASHINGTON, DC, 20005, US

(73) Assignee: Archer-Daniels-Midland Company

(21) Appl. No.: 10/429,260

(22) Filed: May 5, 2003

Related U.S. Application Data
(60) Provisional application No. 60/380,121, filed on May 6, 2002.
(60) Provisional application No. 60/453,722, filed on May 2, 2003.

(51) Int. Cl. A23D 7/00

(52) U.S. Cl. 426/601

(57) ABSTRACT

Diacylglycerol (DAG) oil provides unique health and nutritional advantages to triacylglycerol (TAG) oils. Food products, including nutritional beverages/drinks, nutritional bars, and salad dressings having improved health, nutritional, and even organoleptic properties, are prepared using DAG oil and/or DAG oil-in-water emulsions.

### CROSS-REFERENCE TO RELATED APPLICATIONS

This application claims the benefit of U.S. Provisional Application No. 60/380,121, filed May 6, 2002, and the U.S. Application filed May 2, 2003, entitled, “Foods and Drinks Containing Diacylglycerol” and naming as inventors Brooke Boice, Russ Egbert, Dawn Sikorski, Yvonne Stuchell, and Neil Widlak, the entire contents of which are hereby incorporated by reference.

### FIELD OF THE INVENTION

The present invention relates to food and drink compositions comprising diacylglycerol (DAG) oils.

### BACKGROUND OF THE INVENTION

The primary energy sources available from the typical foods, drinks, and/or supplements consumed by most human populations are sugars and fats. In most diets in the more industrialized countries, high surplus calories are often sourced from higher-fat foods. Much modem medical research suggests that high fat/lipid diets, particularly those high in cholesterol, trans and saturated fatty acids, and triglycerides, can contribute significantly to the development of many diseases, and particularly heart disease, atherosclerosis, high blood pressure, and other cardiovascular diseases. In addition, other disease states, such as cancer, and the general tendency toward obesity in certain populations, are at least in part traceable to diets containing excess fats/lipids.

An alternate source of fat that can provide the gustatory benefits discerned in typical high fat foods (richness, fatty savor, pleasant mouth feel, and other organoleptic characteristics typically enjoyed in higher fat foods) is Diacylglycerol oil (DAG oil). Diglyceride oils are generally described in numerous patents, including, for example, U.S. Pat. Nos. 5,160,759; 6,287,624; and laid-open Japanese patents JP-A 63-301754; JP-A 5-168142; and JP-A 60180. In particular, U.S. Pat. No. 5,160,759 describes oil-in-water emulsions comprising diglyceride oils. U.S. Pat. No. 6,361,980 discloses an enzyme-based process useful for the production of such diglycerides. These patents also demonstrate the health benefits that can be achieved by eating diacylglycerol-containing food products.

Diacylglycerols are naturally occurring compounds found in many edible oils. Through interesterification, an edible oil containing increased level of diacylglycerols has been produced that shows different metabolic effects compared to conventional edible oils. Differences in metabolic pathways between 1,3 diacylglycerol and either 1,2 diacylglycerol or triglycerides allow a greater portion of fatty acids from 1,3 diacylglycerol to be burned as energy rather than being stored as fat. Clinical studies have shown that regular consumption of diacylglycerol oil as part of a sensible diet can help individuals to manage their body weight and body fat. In addition, metabolism of 1,3 diacylglycerol reduces circulating postmeal triglycerides in the bloodstream. Since obesity and elevated blood lipids are associated as risk factors for chronic diseases including cardiovascular disease and Type II diabetes, these lifestyle-related health conditions may be impacted in a beneficial manner with regular consumption of diacylglycerol oils.

### SUMMARY OF THE INVENTION

The present invention relates to food products, including prepared foods, food ingredients, drinks, nutritional and/or health food products (such as health or nutritional bars and the like), comprising DAG oil in place of TAG oil/fat, or comprising oil-in-water emulsions comprising DAG oil in place of TAG oil/fat. Any oil-containing food products could benefit from the use of DAG oil. More particularly specific food products including, but not necessarily limited to, both pourable and spoonable salad dressings, coffee whiteners, nutritional drinks and/or beverages, sauces, gravies, marinades, rubs, nutritional bars, baked goods, caramel, confections, and yogurt, which are typical examples of food systems that benefit, in the sense of appeal to the consumer's palate, from a higher fat content, are contemplated within the scope of the present invention. In a preferred embodiment, the DAG oil component comprises 1,3-diglycerides in an amount from about 40% to about 100% by weight, more preferably at least about 40%, more preferably at least about 45%, more preferably at least about 50%, more preferably at least about 55%, more preferably at least about 60%, more preferably at least about 65%, more preferably at least about 70%, more preferably at least about 75%, more preferably at least about 80%, more preferably at least about 85%, more preferably at least about 90%, and more preferably at least about 95% by weight. In another preferred embodiment, unsaturated fatty acids account for about 50% to about 100% by weight, more preferably at least about 50%, more preferably at least about 55%, more preferably at least about 60%, more preferably at least about 65%, more preferably at least about 70%, more preferably at least about 75%, more preferably at least about 80%, more preferably at least about 85%, more preferably at least about 90%, more preferably at least about 93%, and more preferably at least about 95% by weight of the fatty acid components in the 1,3-diglycerides in the DAG oil. In a further embodiment, the invention is directed to food products containing oil wherein said oil component comprises DAG oil and TAG oil/fat in a ratio of DAG oil to TAG oil/fat from about 1:100 to about 100:0 (100% DAG oil and no TAG oil/fat), preferably from about 1:50, about 1:20, about 1:10, about 1:5, about 1:4, about 1:3, about 1:2, about 1:1, about 2:1, about 3:1, about 4:1, about 5:1, about 10:1, about 20:1, about 50:1, and about 100:1 to about 100:0.

### BRIEF DESCRIPTION OF FIGURES

The foregoing and other features and advantages of the invention will be apparent from the following, more particular description of a preferred embodiment of the invention, as illustrated in the accompanying drawings:

FIG. 1A—Investigation of Functional Properties of DAG vs. TAG High HLB Emulsifiers

FIG. 1B—Investigation of Functional Properties of DAG vs. TAG High HLB Emulsifiers

FIG. 1C—Investigation of Functional Properties of TAG, High HLB Emulsifiers.

FIG. 2A—Investigation of Functional Properties of DAG vs. TAG in 35% oil-in-water Emulsions.

FIG. 2B—Investigation of Functional Properties of DAG and TAG, Lecithins with Increasing HLB.

FIG. 3—Investigation of Functional Properties of DAG vs. TAG, SSL and CCB.

FIG. 4—Descriptive Profile—Vanilla Flavored Soy Drinks.

FIG. 5A—Full Fat French Dressing—DAG vs. TAG.

FIG. 5B—Full Fat French Dressing—DAG vs. TAG.

FIG. 6A—Reduced Fat French Dressing—DAG vs. TAG.

FIG. 6B—Reduced Fat French Dressing—DAG vs. TAG.

FIG. 7A—Full Fat Italian Dressing—DAG vs. TAG.

FIG. 7B—Full Fat Italian Dressing—DAG vs. TAG.

FIG. 8A—Reduced Fat Italian Dressing—DAG vs. TAG.

FIG. 8B—Reduced Fat Italian Dressing—DAG vs. TAG.

FIG. 9A—Separating Italian Dressing—DAG vs. TAG.

FIG. 9B—Separating Italian Dressing—DAG vs. TAG.

FIG. 10A—Full Fat Ranch Dressing—DAG vs. TAG.

FIG. 10B—Full Fat Ranch Dressing—DAG vs. TAG.

FIG. 11A—White Sauces (Milk/Cream Control) at 22° C.

FIG. 11B—White Sauces (Milk/Cream Control) at 50° C.

FIG. 11C—White Sauces (Milk/Cream Control)—DAG vs. TAG

FIG. 11D—White Sauces with Milk/Cream Control at 22° C. and 50° C.

FIG. 11E—White Sauces with Milk/Cream Control at 50° C.

FIG. 12A—White Sauces (NFDM/Butter Control) at 22° C.

FIG. 12B—White Sauces (NFDM/Butter Control) at 50° C.

FIG. 12C—White Sauces (NFDM/Butter Control) with and without SSL—DAG vs. TAG

FIG. 12D—White Sauces (NFDM/Butter Control) at 22° C. and 50° C.

FIG. 12E—White Sauces (NFDM/Butter Control) at 22° C. and 50° C.

FIG. 13A—Brown Gravies at 22° C.

FIG. 13B—Brown Gravies at 50° C.

FIG. 13C—Brown Gravy—DAG vs. TAG

FIG. 13D—Brown Gray at 22° C. and 50° C.

FIG. 13E—Brown Gravy at 50° C.

FIG. 14A—Barbecue Sauce—DAG vs. TAG

FIG. 14B—Barbecue Sauce at 22° C. and 50° C.

### DETAILED DESCRIPTION OF THE INVENTION

The food and drink products of the present invention provide the gustatory and/or organoleptic benefits of typical high-fat foods, without the negative health impacts, through use of diacylglycerol oils in place of triacylglycerol oils. Consumption of diacylglycerol oil can take place through a variety of means, such as through use of diacylglycerol oil in mayonnaise, sauces, gravies, and as a cooking oil in baked goods. Due to the increased polarity of diacylglycerol relative to triacylglycerol, formulating mayonnaise can be difficult. When using diacylglycerol oil to make mayonnaise, stable emulsions are not easily formed using traditional emulsifiers. However, stable emulsions can be achieved by replacing traditional emulsifiers with emulsifiers higher in HLB to compensate for the differences in polarity of the oils.

Formulating sauces and gravies with diacylglycerol oil yield a variety of advantages. In addition to the health benefits associated with diacylglycerol oil consumption, the amount of saturated fat in these products can be reduced and replaced with an oil lower in saturates and higher in polyunsaturates. Products retain their flavor profile, allowing consumers to enjoy eating their favorite items without sacrificing taste.

Baked goods can also be formulated with diacylglycerol oil. Products formulated with diacylglycerol oil were similar in appearance, taste, and texture to their triacylglycerol oil controls, especially in the baked products with higher fat content.

DAG oils, such as those produced by the Kao Corporation of Japan and sold under the brand name Econa®, are used in the preparation of oil-in-water emulsions, using any number of commercially available art-recognized emulsifiers. For example, emulsifiers such as lecithin (standard, acetylated, hydroxylated, and/or modified), sodium stearoyl lactate (SSL) and SSL combinations with distilled monoglycerides, ethoxylated monoglycerides, monodiglycerides, polysorbates, polyglycerol esters, sucrose esters, succinylated monoglycerides, acetylated monoglycerides, lactylated monoglycerides, sorbitan esters, DATEMs, PGPR, and the like may be used in the practice of the present invention. Proteins such as whey protein concentrate/isolate, soy protein isolate/concentrate/flour, and sodium/calcium caseinate can also act as emulsifiers. Of course, as those skilled in the art will recognize, certain emulsifiers will be more or less appropriate to the formulation of certain food and/or drink/beverage products. The present disclosure will allow the skilled practitioner to formulate oil-in-water emulsions appropriate for a variety of end uses and having a range of desired characteristics.

Such oil-in-water emulsions are prepared using art-recognized methods, typically using high speed mixing, shear, and/or homogenization. Emulsifiers are mixed or, if not in the aqueous phase, are melted into the oil phase and the oil/emulsifier mixture is slowly added to the aqueous phase under agitation and/or shear.

Such emulsions prepared with DAG oil typically display a high degree of emulsion stability; stability that is, in fact, in many instances improved over TAG oil emulsions, based on the quantity of emulsion interface remaining after 48 hours. Indeed, the emulsions used in the present invention provided 10%-40% improved stability, depending on the type and amount of emulsifier used. The improvements were particularly noteworthy when standard lecithin or SSL were used with DAG oil.

Oil-in-water emulsions, such as those mentioned above, are present in a variety of food systems, including, for example, salad dressings, coffee whiteners, nutritional drinks/beverages, sauces, gravies, marinades, rubs, caramel, confections, yogurt, and the like. In addition, the inventors have also demonstrated that DAG oil may be directly substituted for TAG in numerous food product formulations such as baked goods and nutritional bars.

Having now provided a general description of the invention, in various embodiments, the following examples are provided to more particularly describe the invention in specific embodiments. These examples are intended to be descriptive and explanatory, and are not intended to limit the scope of the invention as set forth in the appended claims.

### EXAMPLES

### Example 1

### Oil-In-Water (O/W) Emulsions

Materials:

Emulsifiers (Added at 0.5-1.5%, Based on Weight of Added Oil=0.525-1.575 g Per Treatment):

Standard Lecithin (Fluid)—Yelkin TS—(Archer-Daniels-Midland Co., Decatur, Ill. [“ADM”])

Acetylated Lecithin—Thermolec 200—ADM

Acetylated, Hydroxylated Lecithin—Thermolec WFC—ADM

Hydroxylated Lecithin—Yelkin 1018—ADM

Enzyme Modified Lecithin (Lysolecithin)—Blendmax K—Central Soya

Complexed Lecithin—Performix E—ADM (standard lecithin+ethoxylated monodiglycerides)

Sunflower Oil Monoglycerides from Traditional Sunflower Oil—DMG 130—ADM

Sunflower Oil Monoglycerides from Mid-Oleic Sunflower Oil—DMG 130—ADM (discontinued product)

SSL—Paniplex SK—ADM

CCB—Distilled monoglyceride+SSL—ADM (experimental product)

Ethoxylated Monodiglycerides—Mazol 80 K (same ethoxylated monodiglyceride used in Performix E)—BASF Corp.

Polysorbate 60 and 80—ADM Packaged Oils and Sigma Chemical, respectively

Oils (Added at 35% Total Formulation Weight, or 105 g Per Treatment):

Control: 70/30 Soybean oil/Canola oil mixture (to ensure fatty acid composition of vegetable oil vs. DAG oil remained constant (not a source of variability)).

Test: Econa® oil from Kao Corporation of Japan. Oil was tested with no additives to ensure functional differences were attributable to oil source only.

Water (Added at 63.5-64.5%, Depending on Amount of Emulsifier Added, or 190.5-193.5 g Per Treatment):

Deionized water

Procedure:

All emulsions were made at room temperature (25° C.). Emulsifiers were pre-dispersed in oil before emulsions were made. If emulsifier was not liquid at room temperature or if partial solidification of the emulsifier was observed when combined with oil, samples were heated using a hot plate with stirring capability. Heating was carried out until emulsifier was fully melted in the oil phase; temperature of heating depended on melt point of the individual emulsifier. Samples were then cooled to 25° C. Emulsion procedure was as follows:

Distilled water was weighed into 400 ml Nalgene beaker. Emulsification was begun using high shear mixer (PowerGen 700 Fisher Scientific) on setting # 1.5. When mixer was fully up to speed, oil/emulsifier mixture was added slowly (time of addition was approximately 30 seconds). After addition of the oil/emulsifier mixture was completed, the mixture was mixed on setting 1.5 for 30 seconds, moving container in a circular motion to ensure a homogeneous distribution. After mixing the contents were decanted into a clear 250 ml glass graduated cylinder. Levels of oil, water, and emulsion interface were monitored for 15 minutes, 30 minutes, 45 minutes, 1 hour, 4 hours, 24 hours, and 48 hours after initial preparation.

Results:

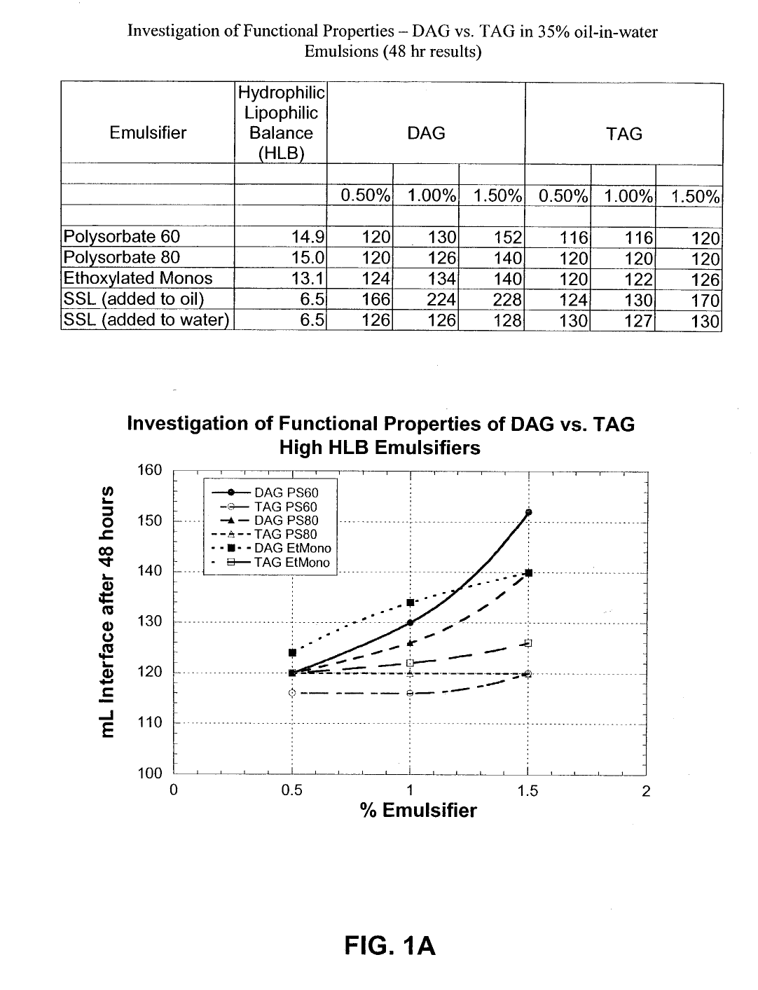

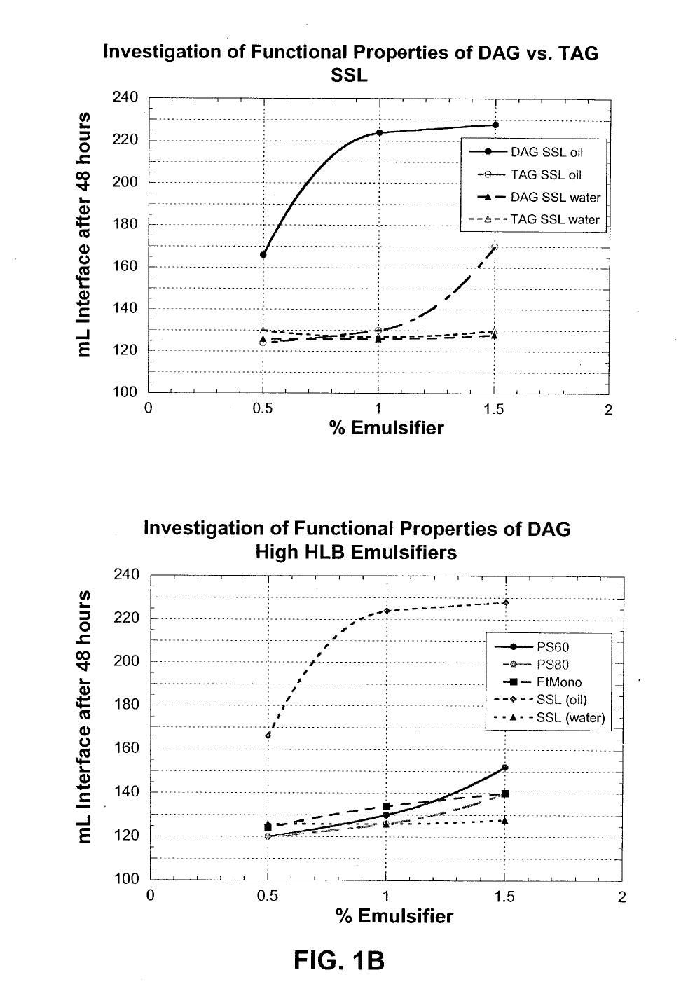

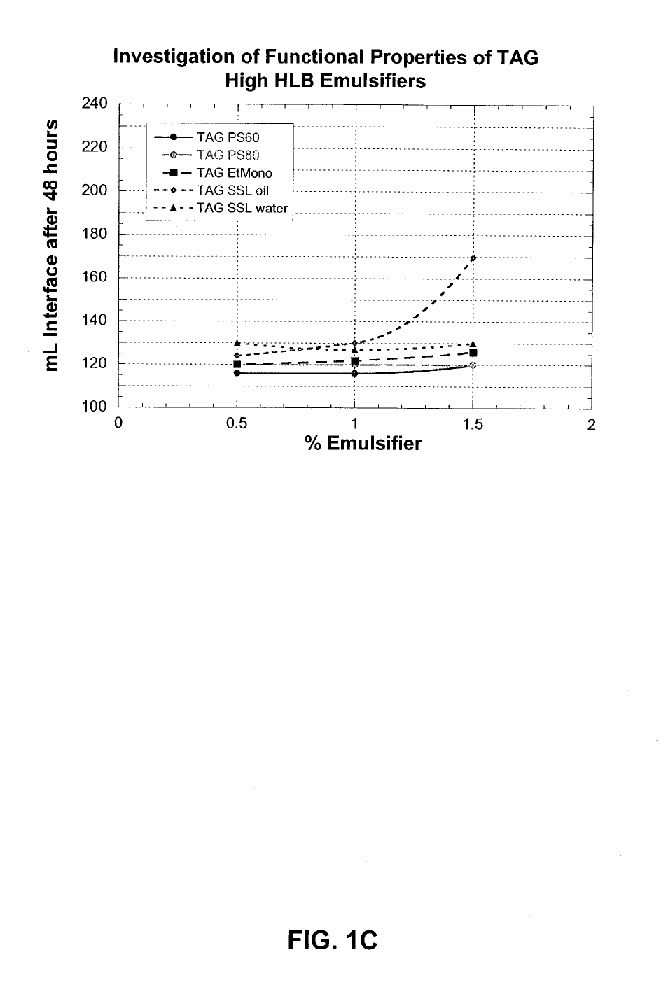

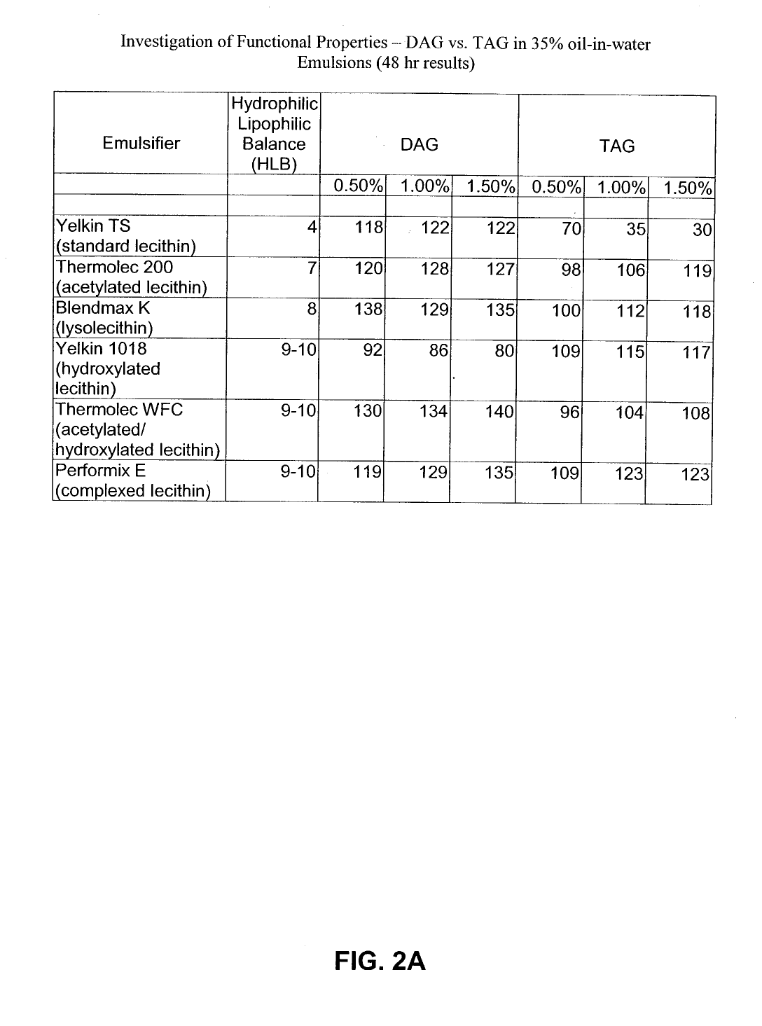

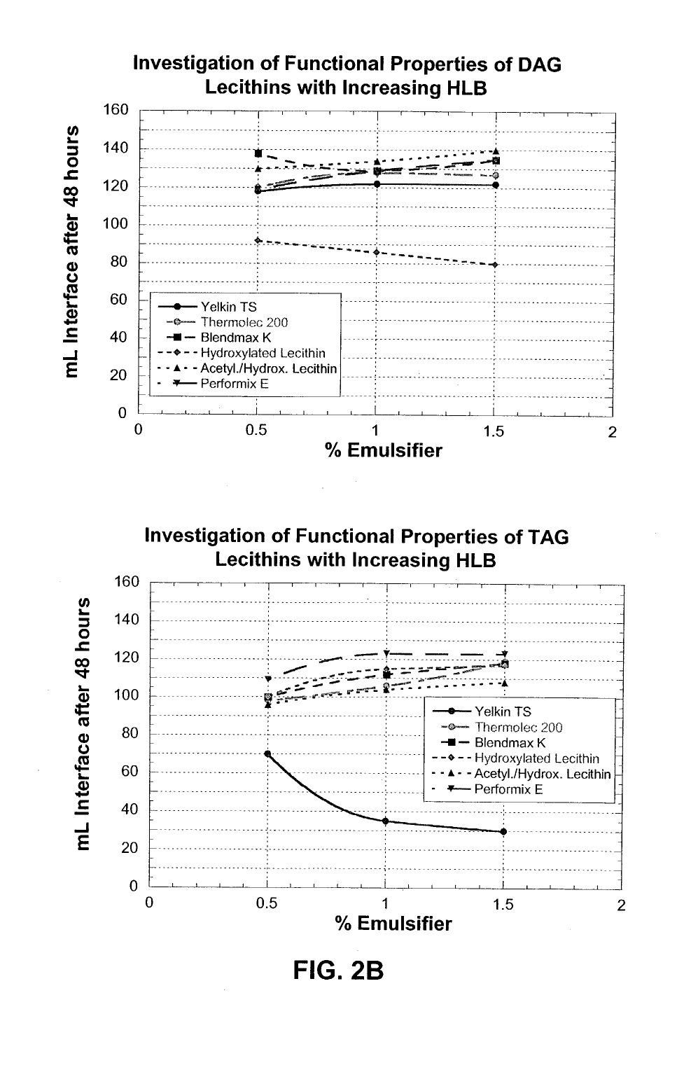

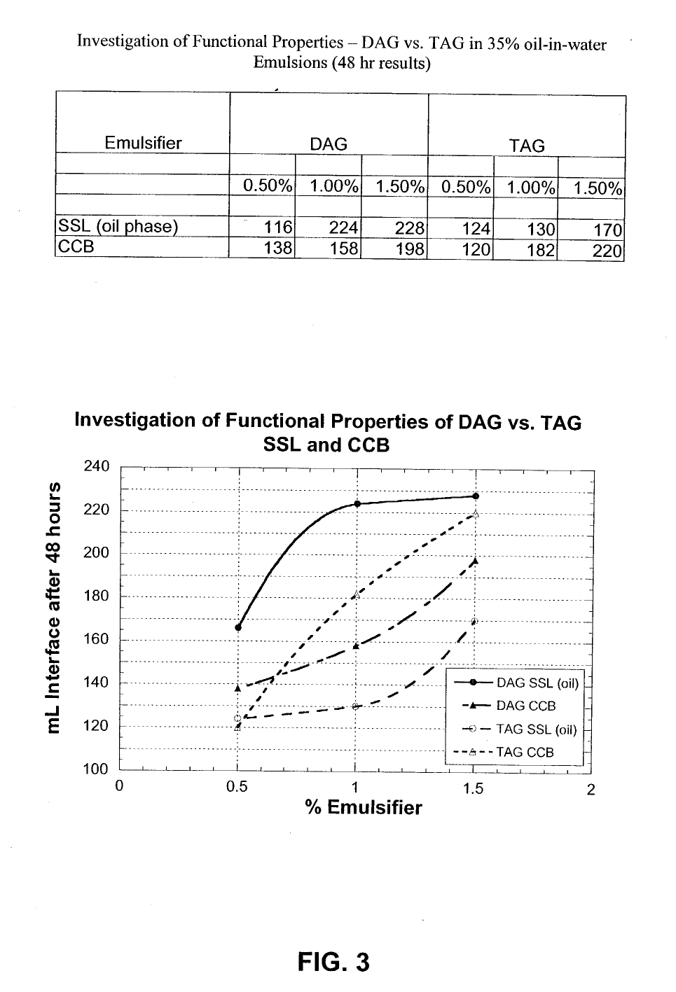

In general, emulsions made with DAG oil displayed a higher degree of emulsion stability than the TAG oil controls, as seen by quantity of emulsion interface remaining after 48 hours. Difference in emulsion stability was 10%-40% greater in DAG compared to TAG, depending on type and level of emulsifier used. Differences seen between emulsions formed when standard lecithin or SSL were used were particularly noteworthy in DAG. See FIGS. 1-3.

The inventors have found DAG oil will not compromise oil-in-water emulsion systems. In fact, results indicate that using DAG oil would improve emulsion stability, translating to either lower usage of emulsifiers or increased emulsion stability for longer storage/shelf life of these foods. Applicable oil-in-water food systems may include salad dressings, coffee whitener, nutritional drinks/beverages, sauces, gravies, marinades, rubs, caramel, confections, and yogurt.

### Example 2

### Materials and Methods—Soy Drinks/Nutritional Beverages

Materials:

French Vanilla Soy Milk Formulation for 1% Fat Drink: The same base formula and manufacturing procedure were used for each product. The only difference was the source oil. However, the base formula may be chosen from any number of drink formulae; those of Tables 1-2 are by way of example only.

Oils Tested:

Control: 70/30 Soybean oil/Canola oil mixture (to ensure fatty acid composition of vegetable oil vs. DAG oil remained constant).

Test 1: Econa® oil from Kao Corporation of Japan. Oil was tested with no additives to ensure functional differences were attributable to oil source only.

Test 2: 76° F. melt coconut oil (used to determine if drinks made using DAG oil would have comparable mouthfeel characteristics to saturated fat source).

Procedure/Results:

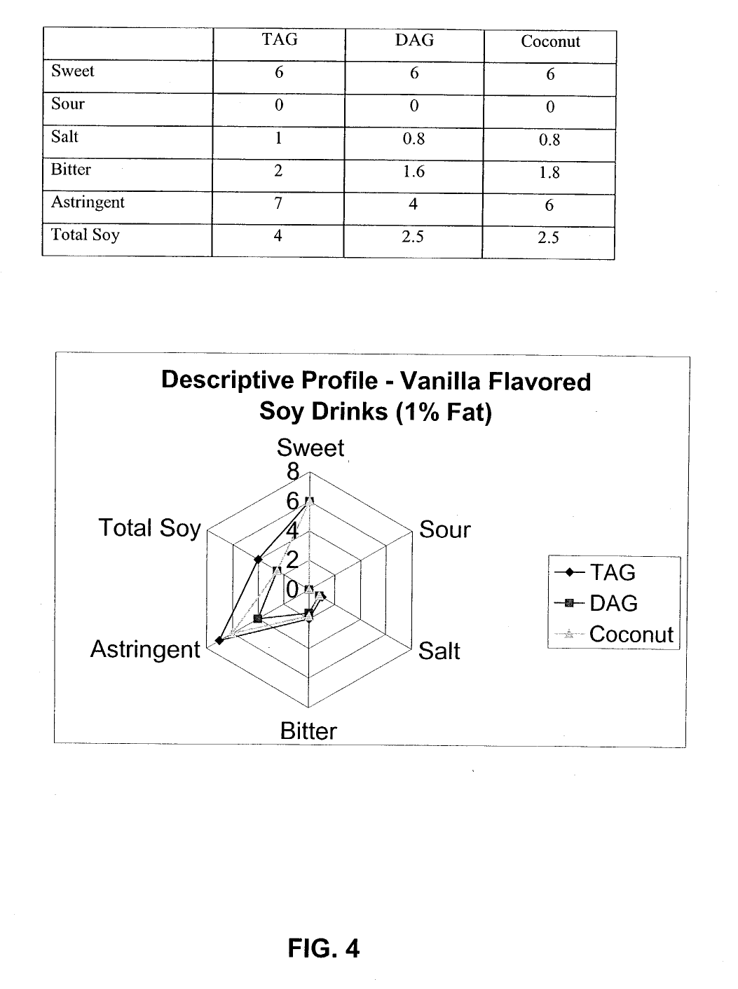

Drinks were processed according to manufacturing procedures listed in the formulation. For example, ProFam 892 was hydrated in 50° C. water for 15-20 minutes. Dry ingredients were dry blended, added to the hydrated protein, and mixed for 5 minutes. Oil was then added and the combined materials were mixed for 5 additional minutes, The material was then subjected to HTST (High Temperature Short Time) pasteurization at 85°-90° C. with two stage homogenization at 2500/500 psi. The resultant material was cooled and packaged. After an equilibration period of one week (to allow flavors in the drink to reach steady-state), the drinks were evaluated by a descriptive panel. In general, panelists found the beverages to be quite similar, although directional differences were seen in astringency and overall soy flavor impact (FIG. 4). In other words, drinks made with DAG oil were found to be directionally less astringent and had less soy flavor than drinks made with TAG oil or coconut oil. These findings indicate that using DAG oil in soy beverages and nutritional drinks may improve flavor and acceptability of these drinks which could be important given the consumer perception typically associated with soy drinks and nutritional beverages.

Insights given by other individuals indicate formulation of drinks with DAG oil yields a beverage not only less astringent, but also one which is smoother, more well-rounded, and more blended (with respect to flavor profile). These attributes would be perceived as more desirable by consumers of nutritional beverage/meal replacment type products. In addition to nutritional drinks/meal replacement beverages, similar observations have been noted in protein-fortified caramels and confections.

TABLE 1

| | 7000 grams | |
|---|---|---|
| Slim-Fast Like Beverage - French Vanilla | % | grams |
| ADM Pro-Fam 892 Soy Protein Isolate | 3.7 | 259 |
| Oil | 1 | 70 |
| ADM Panalite 40 Mono- and Diglycerides | 0.04 | 2.8 |
| Crystalline Fructose | 2.5 | 175 |
| ADM 200 Mesh Xanthan Gum | 0.03 | 2.1 |
| 15 DE Maltodextrin | 1.6 | 112 |
| Masking Agent | 0.5 | 35 |
| FMC Carrageenan SD 389 | 0.025 | 1.75 |
| FMC Avicel RC-591F | 0.25 | 17.5 |
| Salt | 0.1 | 7 |
| Cream Flavor | 0.2 | 14 |
| Natural and Artificial Vanilla | 0.3 | 21 |
| Buddenheim Micronized TriCalcium | 0.33 | 23.1 |
| Phosphate | | |
| Vitamin and Mineral Blend | 0.00079 | 0.055 |
| Water | 89.42421 | 6259.6947 |
| Total: | 100% | 7000 grams |

TABLE 2

| Slim-Fast Like Beverage - French Vanilla | 7000 grams | |
|---|---|---|
| Silk-like Beverage | % | grams |
| ADM Full Fat Soy Flour | 8.77 | 613.9 |
| Oil | 0 | 0 |
| ADM Panalite 40 Mono- and Diglycerides | 0 | 0 |
| Crystalline Fructose | 2.5 | 175 |
| ADM 200 Mesh Xanthan Gum | 0.02 | 1.4 |
| 15 DE Maltodextrin | 0 | 0 |
| Masking Agent | 0.5 | 35 |
| FMC Carrageenan SD 389 | 0.015 | 1.05 |
| FMC Avicel RC-591F | 0.15 | 10.5 |
| Salt | 0.1 | 7 |
| Artificial French Vanilla Flavor | 0.15 | 10.5 |
| Cream Flavor | 0.2 | 14 |
| Natural and Artificial Vanilla | 0.35 | 24.5 |
| Buddenheim Micronized TriCalcium | 0.33 | 23.1 |
| Phosphate | | |
| Vitamin and Mineral Blend | 0.00079 | 0.0553 |
| Water | 86.91421 | 6083.9947 |
| Total: | 100% | 7000 grams |

### Example 3

### Materials and Methods—Salad Dressings (Creamy and Separating Types)

Materials (See Formulations):

Dressings Investigated:

Full Fat (30%) Creamy French

Full Fat (40%) Creamy Italian

Reduced fat (15%) Creamy French

Reduced fat (20%) Creamy Italian

Full Fat (50%) Separating Italian (Good Seasons Italian Mix from Grocery Store)

Full Fat (40%) Ranch

Oils Tested:

Control: 70/30 Soybean oil/Canola oil mixture (to ensure fatty acid composition of vegetable oil vs. DAG oil remained constant (not a source of variability).

Test: Econa oil from Kao Corporation of Japan. Oil was tested with no additives to ensure functional differences were attributable to oil source only.

Water (Reverse Osmosis Type)

Procedure:

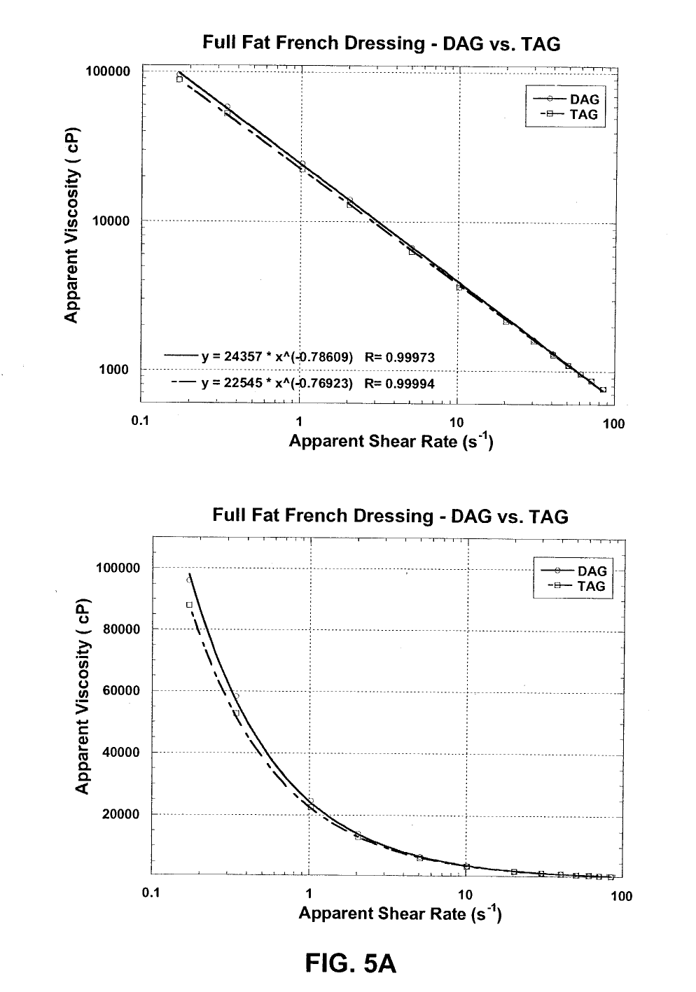

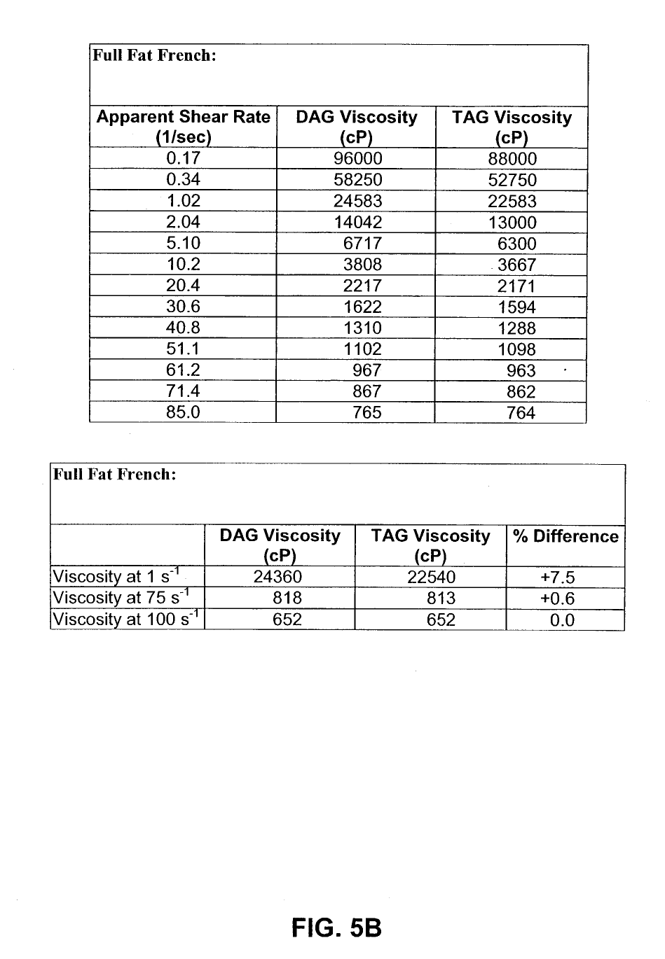

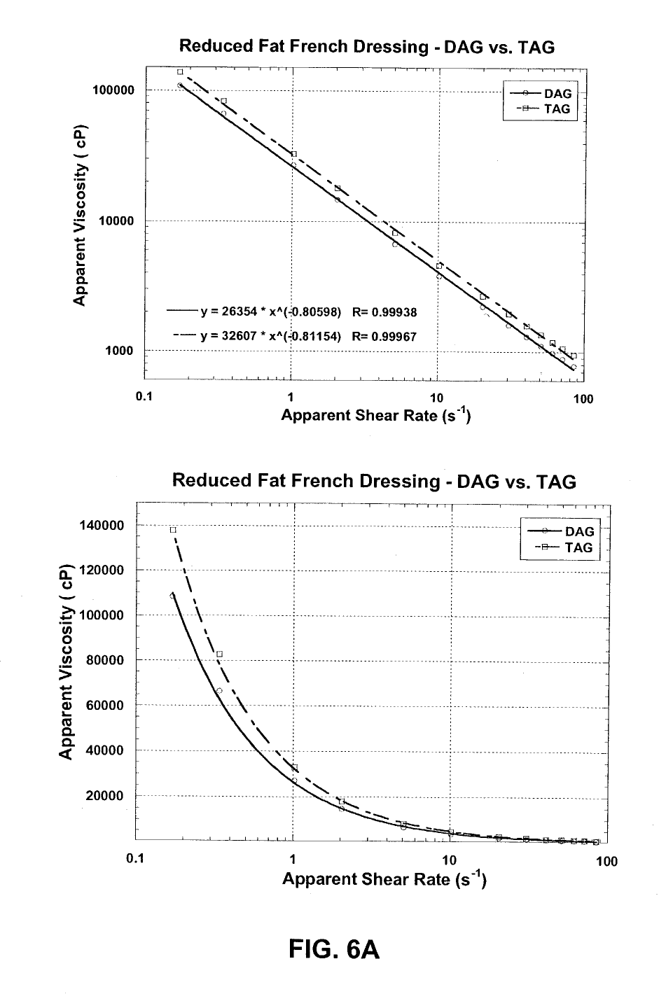

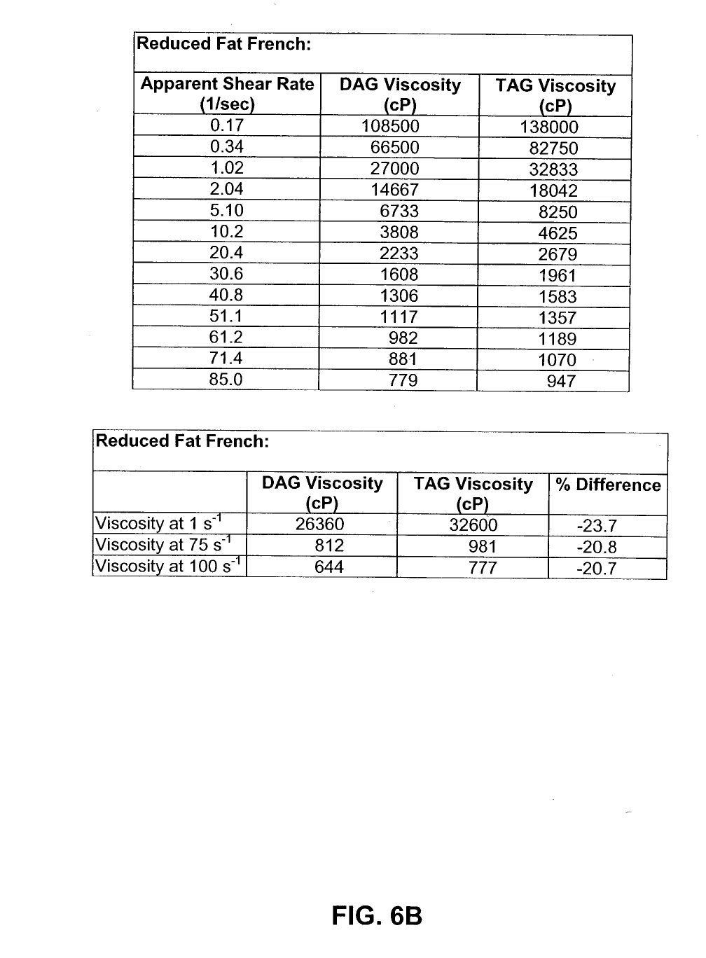

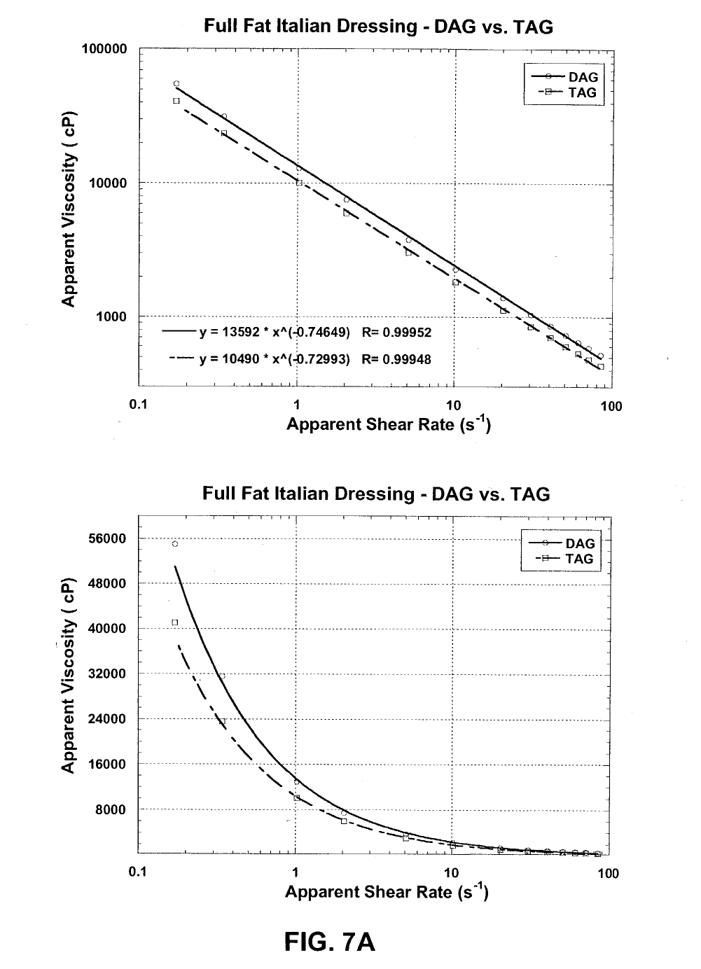

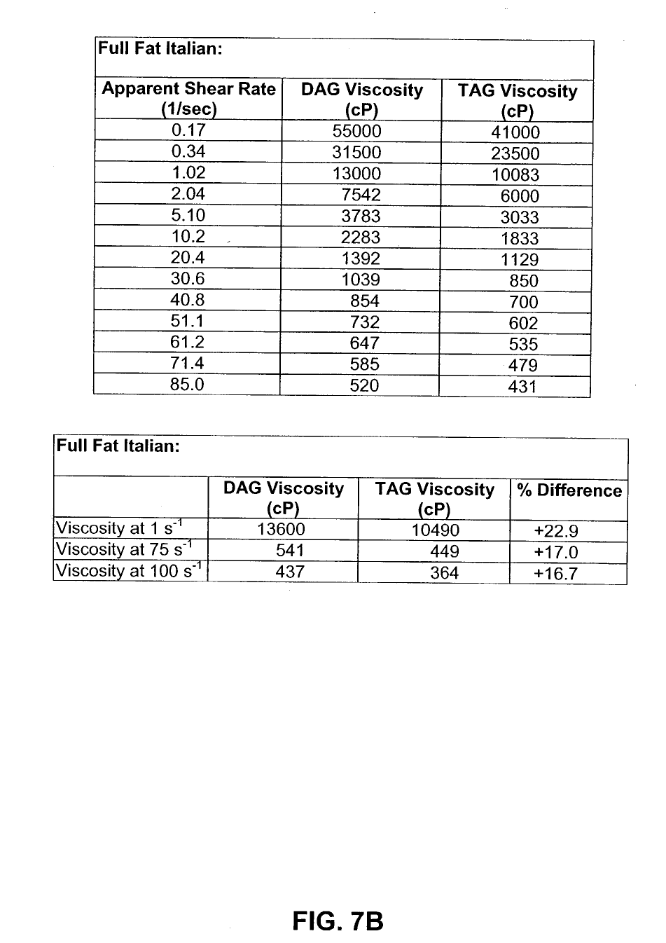

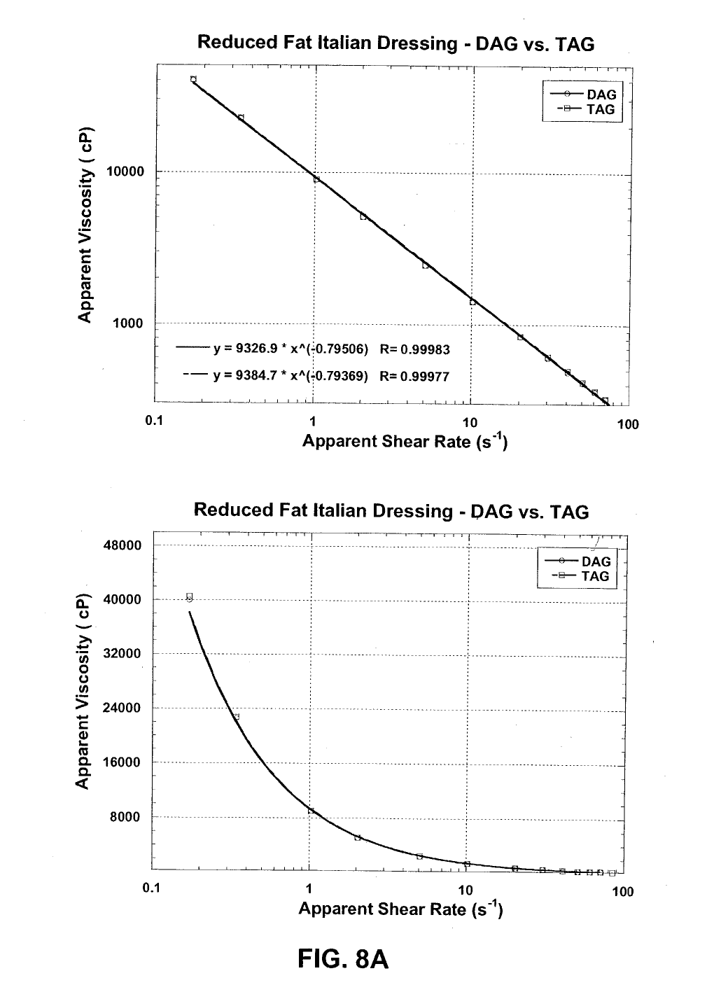

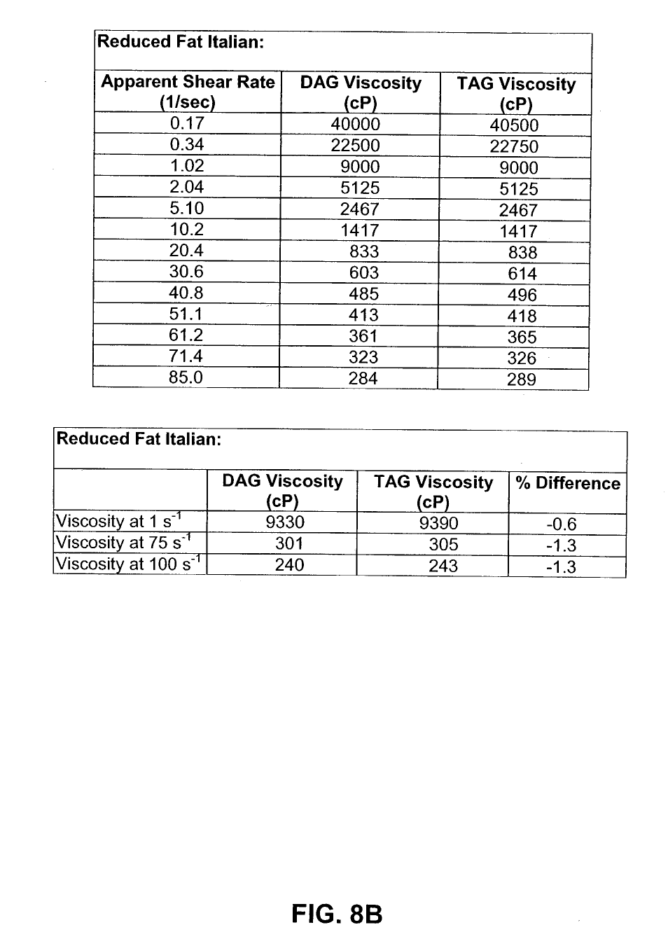

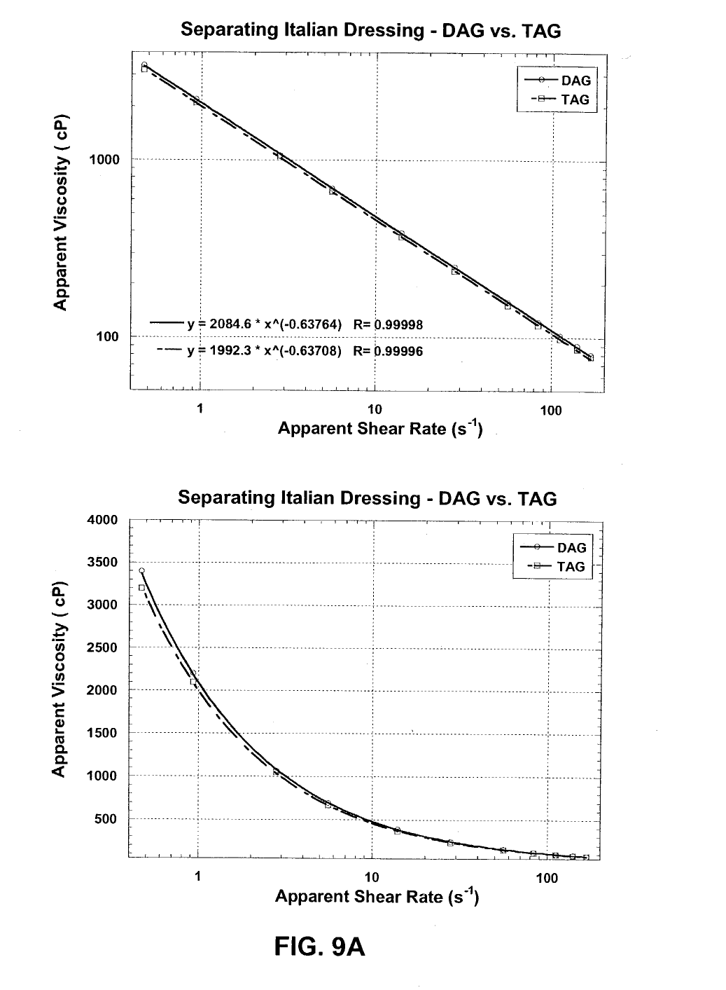

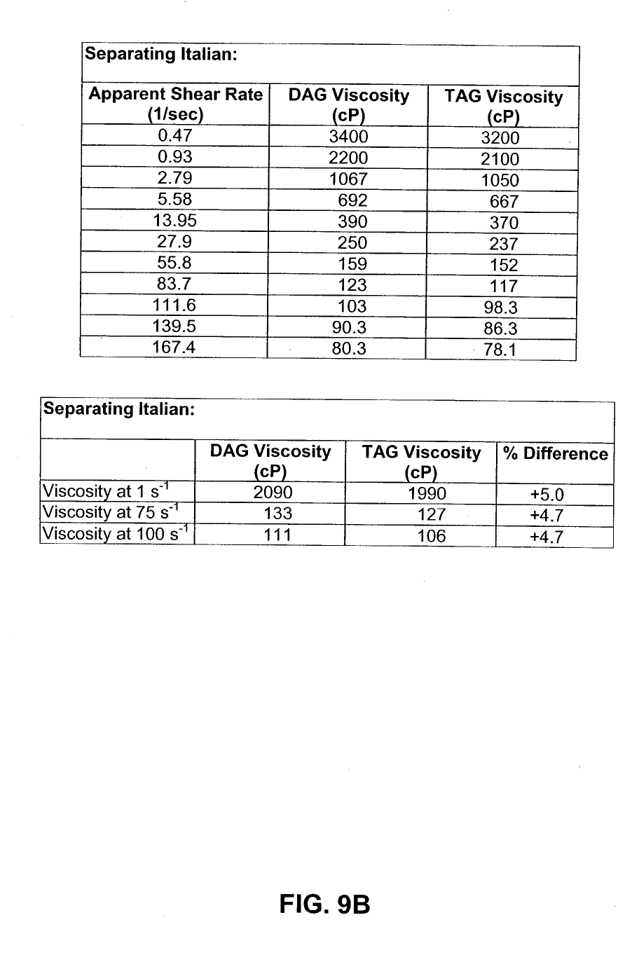

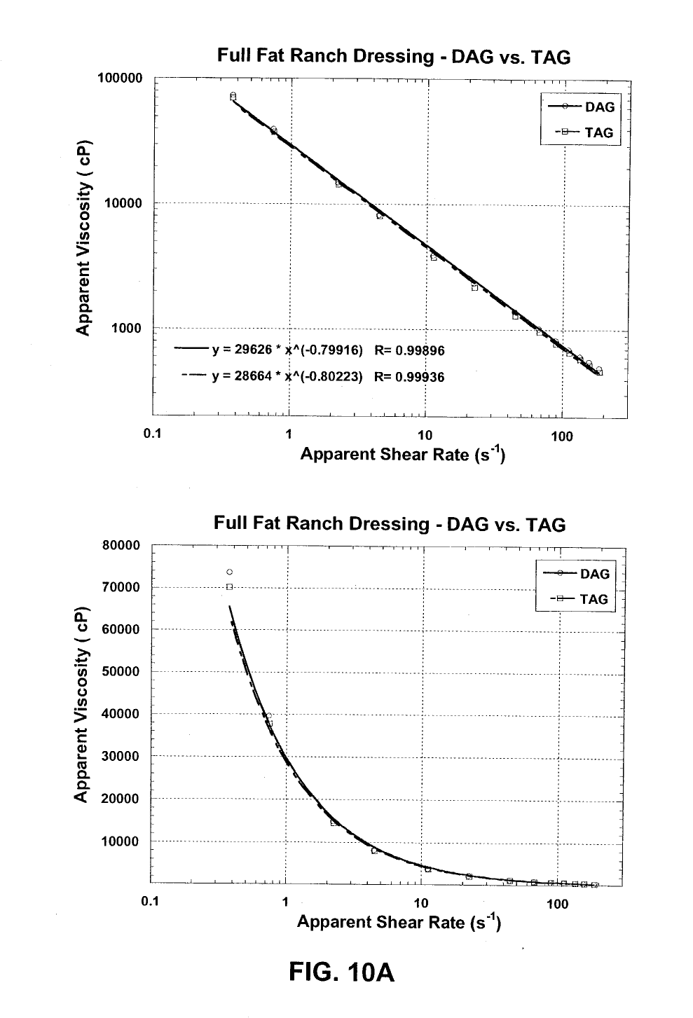

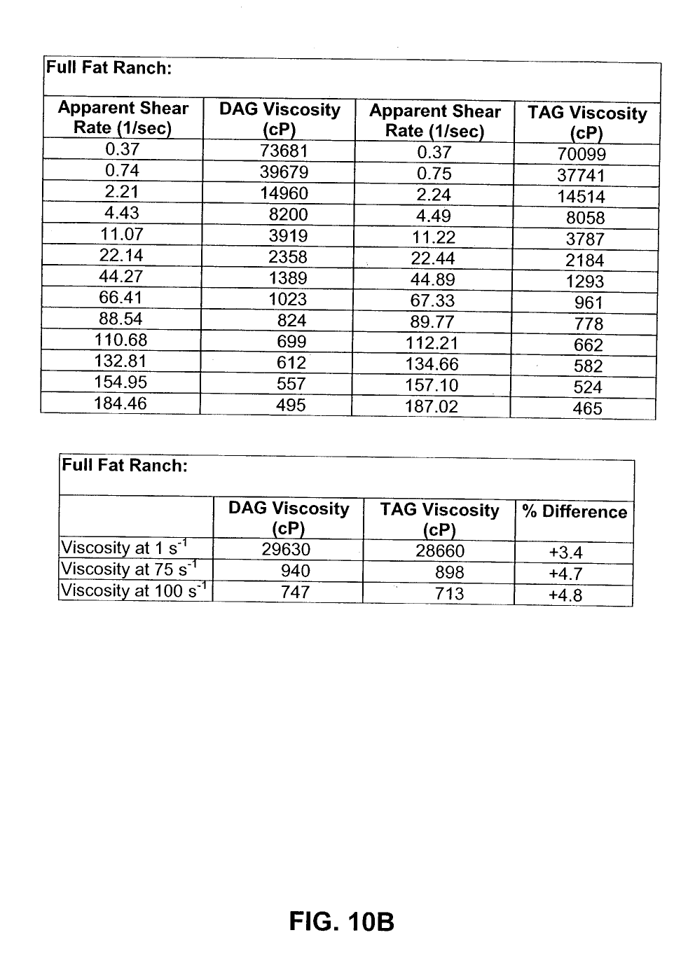

Manufacturing procedures used were typical to the art of salad dressing manufacture. A colloid mill was used to process all creamy type salad dressings while a lab scale mixer was used to process the separating Italian dressing. See Tables 3-7 for representative test formulae. Test results are shown in Tables 8-9 and FIGS. 5-10.

Results:

Creamy Salad Dressings:

Samples were allowed to sit undisturbed for 24 hours after processing through the colloid mill. At that point, viscosity profiles were taken for each dressing using a Brookfield RVT viscometer, fitted with a small sample adapter and Spindle SCA-27. All readings were taken at 22° C. Prior to running the viscosity profile, samples were screened through a tea strainer to separate large spices/pieces from the dressing. Separation of spices was done in this manner to both preserve emulsion integrity and to obtain precise viscosity measurements.

Viscosity results revealed that viscosity of dressings made using DAG oil had higher low shear viscosities in full fat varieties but had lower viscosity profiles in reduced fat versions. Higher viscosities at low shear in full fat dressings is believed to be attributable to the difference in interfacial tension between DAG and TAG. The interfacial tension of DAG is approximately ½ that of TAG, therefore, full fat formulations containing DAG will be better emulsified at equivalent shear rates. Reduction in interfacial tension leads to the formation of smaller fat droplets when shear is applied, yielding a higher viscosity in the finished dressing.

Emulsion stability (of intact dressings—i.e., not pre-strained) was monitored at both room (25° C.) and elevated (40° C.) temperatures. Results indicate that DAG is slightly favored here; less oiling off was observed in full fat Italian and French dressings containing DAG oil.

Dressing cling tests were also performed on all creamy type dressings to determine if there was a difference in the amount of cling one dressing would have over the other. Cling tests were performed on dressings 24 hours after manufacture using a Brookfield LVT Spindle #2. A tare weight was taken on the spindle; the spindle was then placed into the dressing (dressing was well-mixed prior to evaluation so that sample distribution was homogeneous) at a constant depth and removed from the dressing at a consistent rate for each sample tested. Dressing remaining on the spindle after 10 seconds was weighed; 8 observations were taken per treatment and statistical comparisons were made by T-tests at the 95% confidence level. Results showed the full fat dressings made with DAG oil had significantly more cling than the dressings made with TAG. No difference was observed between cling values in reduced fat varieties. Higher cling in full fat DAG preparations was most likely attributable to higher low shear viscosities; equivalent cling in reduced-fat varieties was most likely due to the similarity in low shear viscosity between DAG and TAG preparations. Higher dressing cling for full fat DAG preparations would allow more dressing to cling to the salad pieces rather than running off onto the plate, which would translate to less wasted product and increased consumer acceptability.

Separating Dressings:

Dressings were made with control and test oils using Good Seasons Italian salad dressing mix obtained from the grocery store. To ensure uniform distribution of ingredients, 6 packages were mixed together and evenly distributed into two batches. Products were mixed using a Serrodyne mixer fitted with a propeller blade to ensure consistency between treatments. Vinegar and water were mixed together; dressing mix was added to vinegar/water mixture and stirred for 5 minutes at 400 rpm. Oil was then added slowly (over 60 seconds) into the aqueous phase to achieve the best possible emulsification; mixing speed was gradually increased to 700 rpm as the viscosity of product mix increased. After all of the oil was added, the entire mixture was stirred at 700 rpm for 5 minutes. Dressings were partitioned into 250 ml graduated cylinders immediately after mixing; in addition, viscosity readings were taken on both dressings using the same protocol as in the creamy dressing viscosity profiles. No notable differences were seen in viscosity profiles for the two dressings. Dressings were monitored over one week to examine any differences in separation. The dressing made with DAG had an even distribution of spices and showed no settling of particulates for 2 days after preparation. The dressing made with TAG showed definite settling within 24 hours after preparation. Therefore, dressings made with DAG are more stable over time and have a better, more homogeneous distribution of spices than dressings made with TAG. Differences between the two dressings are most likely related to differences in interfacial tension between DAG and TAG which translate to differences in emulsion formation and stability.

Clearly, DAG oil is easily incorporated into salad dressings and can deliver some noteworthy benefits in full fat varieties and can be substituted with no functional differences in reduced fat varieties. All dressings were processed with the same ease, so no changes in manufacturing procedure would be required when using DAG oil. Results indicate using DAG oil would improve emulsion stability, dressing cling, and ensure a more homogeneous, even suspension of spices.

TABLE 3

| | 2000 grams | | | |
|---|---|---|---|---|
| | DAG | | TAG | |
| Creamy French Dressing | % | grams | % | grams |
| water | 24.07 | 481.40 | 24.07 | 481.40 |
| sugar | 20.00 | 400.00 | 20.00 | 400.00 |
| vinegar, 100 grain | 14.50 | 290.00 | 14.50 | 290.00 |
| tomato paste | 8.50 | 170.00 | 8.50 | 170.00 |
| ADM Xanthan Gum, 80 mesh | 0.35 | 7.00 | 0.35 | 7.00 |
| soybean oil | — | — | 21.00 | 420.00 |
| canola oil | — | — | 9.00 | 180.00 |
| DAG oil | 30.00 | 600.00 | — | — |
| salt | 2.00 | 40.00 | 2.00 | 40.00 |
| onion powder | 0.50 | 10.00 | 0.50 | 10.00 |
| potassium sorbate | 0.05 | 1.00 | 0.05 | 1.00 |
| EDTA | 0.03 | 0.60 | 0.03 | 0.60 |
| color | — | to suit | — | to suit |
| | 100.00 | 2000.00 | 100.00 | 2000.00 |

Procedure:
1. Dry blend xanthan gum in sufficient sugar to disperse.
2. Weigh water into a large container. Add xanthan gum blend and stir
with high shear mixing until the gum is hydrated and no lumps
are evident.
3. Add sugar, vinegar and tomato paste and stir until smooth.
4. Add oil, increasing speed of stirring to keep mixture moving and create
emulsion.
5. Combine remaining ingredients and add to dressing. Mix 1-2 minutes.
6. Process using a colloid mill at an appropriate gap setting.
7. Package.

TABLE 4

| | 2000 grams | | | |
|---|---|---|---|---|
| Reduced-Fat Creamy French | DAG | | TAG | |
| Dressing | % | grams | % | grams |
| water | 24.54 | 490.80 | 24.54 | 490.80 |
| sugar | 10.00 | 200.00 | 10.00 | 200.00 |
| ADM Corn Syrup, 62/43 | 18.50 | 370.00 | 18.50 | 370.00 |
| vinegar, 100 grain | 14.50 | 290.00 | 14.50 | 290.00 |
| tomato paste | 14.50 | 290.00 | 14.50 | 290.00 |
| ADM Xanthan Gum, 80 mesh | 0.40 | 8.00 | 0.40 | 8.00 |
| soybean oil | — | — | 10.50 | 210.00 |
| canola oil | — | — | 4.50 | 90.00 |
| DAG oil | 15.00 | 300.00 | — | — |
| salt | 2.00 | 40.00 | 2.00 | 40.00 |
| onion powder | 0.45 | 9.00 | 0.45 | 9.00 |
| potassium sorbate | 0.05 | 1.00 | 0.05 | 1.00 |
| EDTA | 0.03 | 0.60 | 0.03 | 0.60 |
| ADM Vitamin E | 0.03 | 0.60 | 0.03 | 0.60 |
| color | — | to suit | — | to suit |
| | 100.00 | 2000.00 | 100.00 | 2000.00 |

Procedure:
1. Dry blend xanthan gum in sufficient sugar to disperse.
2. Weigh water into a large container. Add xanthan gum blend using high
shear mixing and stir until the gum is hydrated and no lumps are evi-
dent.
3. Add sugar, vinegar and tomato paste and stir until smooth.
4. Add oil, increasing speed of stirring to keep mixture moving and create
emulsion.
5. Add remaining ingredients and add to dressing. Mix 1-2 minutes.
6. Process dressing using a colloid mill set at an appropriate gap.
7. Package.

TABLE 5

| | 2000 grams | | | |
|---|---|---|---|---|
| | DAG | | TAG | |
| Creamy Italian Dressing | % | grams | % | grams |
| water | 17.57 | 351.40 | 17.57 | 351.40 |
| sugar | 29.00 | 580.00 | 29.00 | 580.00 |
| vinegar, 100 grain | 1.50 | 30.00 | 1.50 | 30.00 |
| lemon juice, single strength | 2.50 | 50.00 | 2.50 | 50.00 |
| ADM Xanthan Gum, 80 mesh | 0.23 | 4.60 | 0.23 | 4.60 |
| soybean oil | — | — | 28.00 | 560.00 |
| canola oil | — | — | 12.00 | 240.00 |
| DAG oil | 40.00 | 800.00 | — | — |
| minced garlic (in oil) | 2.50 | 50.00 | 2.50 | 50.00 |
| ground parmesan and romano | 2.25 | 45.00 | 2.25 | 45.00 |
| cheese | | | | |
| salt | 2.50 | 50.00 | 2.50 | 50.00 |
| egg yolk | 0.60 | 12.00 | 0.60 | 12.00 |
| garlic powder | 0.50 | 10.00 | 0.50 | 10.00 |
| minced onion | 0.50 | 10.00 | 0.50 | 10.00 |
| dried red peppers, crushed | 0.10 | 2.00 | 0.10 | 2.00 |
| oregano, dried | 0.10 | 2.00 | 0.10 | 2.00 |
| parsley flakes | 0.07 | 1.40 | 0.07 | 1.40 |
| potassium sorbate | 0.05 | 1.00 | 0.05 | 1.00 |
| EDTA | 0.03 | 0.60 | 0.03 | 0.60 |
| | 100.00% | 2000.00 | 100.00% | 2000.00 |

Procedure:
1. Dry blend xanthan gum in sufficient sugar (1:10) to disperse.
2. Weigh water into a large container. Add xanthan gum blend with high
shear mixing and stir until the gum is hydrated and no lumps are evi-
dent.
3. Add remaining sugar, vinegar and lemon juice and stir until smooth.
4. Add egg yolk and oil, increasing speed of stirring to keep mixture
moving and create emulsion.
5. Combine remaining powdered ingredients and add to dressing. Mix
1-2 minutes, increasing agitation as needed. Add EDTA.
6. Process through a colloid mill set at an appropriate gap.
7. Add remaining articulate spices and mix well.
8. Package.

TABLE 6

| | 2000 grams | | | |
|---|---|---|---|---|
| Reduced-Fat Creamy Italian | DAG | | TAG | |
| Dressing | % | grams | % | grams |
| water | 46.12 | 922.40 | 46.12 | 922.40 |
| vinegar, 100 grain | 14.50 | 290.00 | 14.50 | 290.00 |
| ADM 62/43 Corn Syrup | 8.75 | 175.00 | 8.75 | 175.00 |
| lemon juice, single strength | 2.50 | 50.00 | 2.50 | 50.00 |
| ADM Xanthan Gum, 80 mesh | 0.35 | 7.00 | 0.35 | 7.00 |
| soybean oil | — | — | 14.00 | 280.00 |
| canola oil | — | — | 6.00 | 120.00 |
| DAG oil | 20.00 | 400.00 | — | — |
| minced garlic (in oil) | 2.50 | 50.00 | 2.50 | 50.00 |
| ground parmesan and romano | 2.25 | 45.00 | 2.25 | 45.00 |
| cheese | | | | |
| salt | 1.00 | 20.00 | 1.00 | 20.00 |
| egg yolk | 0.65 | 13.00 | 0.65 | 13.00 |
| garlic powder | 0.50 | 10.00 | 0.50 | 10.00 |
| minced onion | 0.50 | 10.00 | 0.50 | 10.00 |
| dried red peppers, crushed | 0.10 | 2.00 | 0.10 | 2.00 |
| oregano, dried | 0.10 | 2.00 | 0.10 | 2.00 |
| parsley flakes | 0.07 | 1.40 | 0.07 | 1.40 |
| vitamin E ascorbate | 0.03 | 0.60 | 0.03 | 0.60 |
| potassium sorbate | 0.05 | 1.00 | 0.05 | 1.00 |
| EDTA | 0.03 | 0.60 | 0.03 | 0.60 |
| | 100.00 | 2000.00 | 100.00 | 2000.00 |

Procedure:
1. Slurry xanthan gum in sufficient oil to make a fluid mixture.
2. Weigh water into a large container. Add xanthan gum slurry using high
shear mixing and stir until the gum is hydrated and no lumps are evi-
dent.
3. Add corn syrup, vinegar and lemon juice and stir until smooth.
4. Add egg yolk and oil, increasing speed of stirring to keep mixture
moving and create emulsion.
5. Combine remaining dry powdered ingredients and add to dressing.
Mix 1-2 minutes, increasing agitation as needed. Add EDTA.
6. Process dressing through a colloid mill set at the appropriate gap.
7. Stir remaining particulate spices into dressing.
8. Package.

TABLE 7

| | 1000 grams | | | |
|---|---|---|---|---|
| | DAG | | TAG | |
| Full-Fat Ranch Dressing | % | grams | % | grams |
| water | 37.64 | 376.40 | 37.64 | 376.40 |
| vinegar, 100 grain | 5.75 | 57.50 | 5.75 | 57.50 |
| sugar | 3.15 | 31.50 | 3.15 | 31.50 |
| Non-fat Buttermilk Powder (Dairy | 1.50 | 15.00 | 1.50 | 15.00 |
| Farmers of America) | | | | |
| lactic acid (85%) | 0.45 | 4.50 | 0.45 | 4.50 |
| UltraSperse 2000 Modified food | 0.45 | 4.50 | 0.45 | 4.50 |
| starch (National) | | | | |
| lemon juice, single strength | 0.40 | 4.00 | 0.40 | 4.00 |
| Xanthan gum | 0.25 | 2.50 | 0.25 | 2.50 |
| vegetable oil | — | — | 40.00 | 400.00 |
| DAG oil | 40.00 | 400.00 | — | — |
| egg yolk | 5.30 | 53.00 | 5.30 | 53.00 |
| salt | 1.70 | 17.00 | 1.70 | 17.00 |
| Sour cream dairy powder (Kerry) | 1.00 | 10.00 | 1.00 | 10.00 |
| Maltodextrin, Clintose CR10 | 0.80 | 8.00 | 0.80 | 8.00 |
| onion powder | 0.65 | 6.50 | 0.65 | 6.50 |
| garlic powder | 0.45 | 4.50 | 0.45 | 4.50 |
| MSG | 0.25 | 2.50 | 0.25 | 2.50 |
| sweet basil, dried | 0.10 | 1.00 | 0.10 | 1.00 |
| ground black pepper | 0.05 | 0.50 | 0.05 | 0.50 |
| chives | 0.03 | 0.30 | 0.03 | 0.30 |
| potassium sorbate | 0.05 | 0.50 | 0.05 | 0.50 |
| EDTA | 0.03 | 0.30 | 0.03 | 0.30 |
| | 100.00 | 1000.00 | 100.00 | 1000.00 |

Procedure:
1. Dry blend sugar, buttermilk powder and xanthan gum.
2. Weigh water into a large container. Add xanthan gum blend using high
shear mixing and stir until the gum is hydrated and no lumps are evi-
dent.
3. Add modified food starch to slurry. Stir an additional 3-5 minutes.
4. Add vinegar, lactic acid and lemon juice.
5. Add egg yolks and stir until smooth. Add oil, increasing speed of
stirring to keep mixture moving and create emulsion.
6. Combine remaining dry powdered ingredients and add to dressing. Mix
1-2 minutes, increasing agitation as needed. Add EDTA.
7. Process dressing using a colloid mill set at an appropriate gap.
8. Stir in remaining particulate spices.
9. Package.

TABLE 8
Functionality Test-DAG vs. TAG in Salad Dressings
Cling Test in Low Fat and Full Fat Dressings

| Dressing Type | Fat Level | Fat Type | Cling (g on #2 LV Spindle after 10 seconds) | | | | | | | | Mean | Std. Dev. |
|---|---|---|---|---|---|---|---|---|---|---|---|---|
| French | Full Fat | DAG | 2.71 | 2.53 | 2.9 | 2.81 | 2.85 | 2.76 | 2.67 | 2.52 | 2.7188 | 0.14025 |
| | | TAG | 2.46 | 2.40 | 2.44 | 2.40 | 2.79 | 2.79 | 2.67 | 2.40 | 2.5438 | 0.17606 |
| | Red Fat | DAG | 2.59 | 2.53 | 2.32 | 2.64 | 2.68 | 2.29 | 2.25 | 2.48 | 2.4725 | 0.16663 |
| | | TAG | 2.76 | 2.69 | 2.76 | 2.6 | 2.46 | 2.65 | 2.46 | 2.61 | 2.6238 | 0.11747 |
| Italian | Full Fat | DAG | 2.35 | 2.15 | 2.34 | 2.21 | 2.38 | 2.13 | 2.24 | 2.37 | 2.2713 | 0.10134 |
| | | TAG | 2.04 | 2.07 | 1.89 | 2.04 | 1.93 | 1.99 | 2.09 | 2.08 | 2.0163 | 0.07328 |
| | Red Fat | DAG | 1.55 | 1.59 | 1.45 | 1.44 | 1.37 | 1.44 | 1.46 | 1.50 | 1.4750 | 0.06949 |
| | | TAG | 1.54 | 1.45 | 1.40 | 1.50 | 1.52 | 1.42 | 1.36 | 1.50 | 1.4613 | 0.06379 |

TABLE 9

| Functionality Tests - DAG vs. TAG | | | Cling Test Results - Statistical | | |
|---|---|---|---|---|---|
| in Salad Dressings | | | Analysis | | |
| French Dressing - Full Fat*** | | | Italian Dressing - Full Fat*** | | |
| t-Test: Two-Sample Assuming Equal | | | t-Test: Two-Sample Assuming | | |
| Variances | | | Equal Variances | | |
| | DAG | TAG | | DAG | TAG |
| Mean | 2.71875 | 2.54375 | Mean | 2.27125 | 2.01625 |
| Variance | 0.01967 | 0.030998 | Variance | 0.01027 | 0.00537 |
| Observa- | 8 | 8 | Observa- | 8 | 8 |
| tions | | | tions | | |
| Pooled | 0.025334 | | Pooled | 0.00782 | |
| Variance | | | Variance | | |
| Hypoth- | 0 | | Hypoth- | 0 | |
| esized | | | esized | | |
| Mean Dif- | | | Mean Dif- | | |
| ference | | | ference | | |
| df | 14 | | df | 14 | |
| t Stat | 2.198957 | | t Stat | 5.767355 | |
| P(T <= t) | 0.022594 | | P(T <= t) | 2.44E−05 | |
| one-tail | | | one-tail | | |
| t Critical | 1.761309 | | t Critical | 1.761309 | |
| one-tail | | | one-tail | | |
| P(T <= t) | 0.045189 | | P(T <= t) | 4.87E−05 | |
| two-tail | | | two-tail | | |
| t Critical | 2.144789 | | t Critical | 2.144789 | |
| two-tail | | | two-tail | | |

| French Dressing - Reduced Fat | | | Italian Dressing - Reduced Fat | | |
|---|---|---|---|---|---|
| t-Test: Two-Sample Assuming Equal | | | t-Test: Two-Sample Assuming | | |
| Variances | | | Equal Variances | | |
| | DAG | TAG | | DAG | TAG |
| Mean | 2.4725 | 2.62375 | Mean | 1.475 | 1.46125 |
| Variance | 0.027764 | 0.013798 | Variance | 0.004829 | 0.00407 |
| Observa- | 8 | 8 | Observa- | 8 | 8 |
| tions | | | tions | | |
| Pooled | 0.020781 | | Pooled | 0.004449 | |
| Variance | | | Variance | | |
| Hypoth- | 0 | | Hypoth- | 0 | |
| esized | | | esized | | |
| Mean Dif- | | | Mean Dif- | | |
| ference | | | ference | | |
| df | 14 | | df | 14 | |
| t Stat | −2.09841 | | t Stat | 0.412284 | |
| P(T <= t) | 0.027247 | | P(T <= t) | 0.343188 | |
| one-tail | | | one-tail | | |
| t Critical | 1.761309 | | t Critical | 1.761309 | |
| one-tail | | | one-tail | | |
| P(T <= t) | 0.054494 | | P(T <= t) | 0.686375 | |
| two-tail | | | two-tail | | |
| t Critical | 2.144789 | | t Critical | 2.144789 | |
| two-tail | | | two-tail | | |

***denotes statistically significant differences between means at the 95% confidence level

### Example 4

### Materials and Methods—Sauces, Gravies, Marinades, and Rubs

Description: Diacylglycerol oil was investigated in Sauces, Gravies, Marinades, and Rubs to determine possible differences between its utilization vs. triacylglycerol oil in white sauces, cheese sauces, barbeque sauce, gravies, frozen entrees, and soups. Knowledge gained from these evaluations can also be extended to salad dressings, meal replacements, and coffee whitener systems.

Oils Tested (White Sauce Using Milk and Cream as Model System):

Typical Control—common products used in production of white cream sauce: dairy fat (from light cream and whole milk)

TAG Control: 70/30 Soybean oil/canola oil mixture (to keep fatty acid composition between TAG vs. DAG constant [not a source of variability])

Test: Econa oil from Kao Corporation of Japan. Oil was tested with no additives to ensure functional differences were attributable to oil source only.

Note: Since a stable emulsion had already been formed in the milk and cream (products used had been pasteurized and homogenized prior to evaluation), these products did not require the use of any additional emulsifiers or stabilizing agents. However, since the DAG and TAG controls were added separately, addition of emulsifiers and stabilizers were required to yield a comparable emulsion in the finished product. Emulsifiers used were SSL, deoiled lecithin, and fluid lecithin, though emulsifiers that can be used would not be limited to the above-mentioned list. Xanthan gum was used as the stabilizing agent, though other stabilizers/thickeners could be used alone, or in combination, with xanthan gum.

Oils Tested (White Sauce Using Non-Fat Dry Milk (NFDM) and Butter as Model System)

TAG and DAG oils were tested in the production of white sauce using non-fat dry milk and butter as the model system.

Oils Tested (Brown Gravy):

Typical Control—common product used in production of brown gravy: partially hydrogenated vegetable oil shortening (Crisco used in example)

TAG Control: 70/30 Soybean oil/canola oil mixture (to keep fatty acid composition between TAG vs. DAG constant [not a source of variability])

Test: Econa oil from Kao Corporation of Japan. Oil was tested with no additives to ensure functional differences were attributable to oil source only.

Note: since a solid fat was being replaced with a liquid oil in this formulation, xanthan gum was added as a stabilizer/thickening agent to thicken the aqueous phase to approximate the viscosity of the gravy containing the solid fat upon cooling. Use of other stabilizers/thickeners and blends of stabilizers/thickeners could also be applied in the spirit of this part of the invention.

Oils Tested (Barbeque Sauce):

TAG Control: 70/30 Soybean oil/canola oil mixture (to keep fatty acid composition between TAG vs. DAG constant [not a source of variability])

Test: Econa oil from Kao Corporation of Japan. Oil was tested with no additives to ensure functional differences were attributable to oil source only.

Oils Tested (Marinade Rub):

TAG Control: 70/30 Soybean oil/canola oil mixture (to keep fatty acid composition between TAG vs. DAG constant [not a source of variability])

Test: Econa oil from Kao Corporation of Japan. Oil was tested with no additives to ensure functional differences were attributable to oil source only.

Evaluation Parameters:

Viscosity

Mouthfeel

Appearance

Representative Formulas:

TABLE 10

| | Control (Dairy | | |
|---|---|---|---|
| | Fat) | Control (TAG) | DAG |
| White Cream Sauce | % | % | % |
| National 465 Modified Food | 2.50 | 2.50 | 2.50 |
| Starch | | | |
| Butter Buds (8x) | 1.54 | 1.54 | 1.54 |
| Salt | 0.50 | 0.50 | 0.50 |
| All Purpose Flour | 0.30 | 0.30 | 0.30 |
| Sweet Whey | 0.20 | 0.20 | 0.20 |
| Celery Salt | 0.05 | 0.05 | 0.05 |
| Ground White Pepper | 0.03 | 0.03 | 0.03 |
| Onion Powder | 0.01 | 0.01 | 0.01 |
| Whole Milk | 69.50 | — | — |
| Light Cream | 25.37 | — | — |
| ADM Xanthan Gum | — | 0.10 | 0.10 |
| SSL | — | 0.20 | 0.20 |
| Nonfat Dry Milk | — | 8.50 | 8.50 |
| Oil | — | 7.30 | 7.30 |
| Water | — | 78.77 | 78.77 |
| Total: | 100.00 | 100.00 | 100.00 |

Procedure (control):
1. Combine and pre-blend dry ingredients
2. Combine milk and light cream. Add dry ingredients to liquids under
moderate agitation.
3. Heat mixture to 190 F. with constant stirring. Hold at 190 F. for
10 minutes.
4. Cover and cool.
Procedure (TAG and DAG):
1. Combine and pre-blend dry ingredients.
2. Combine water and oil. Add dry ingredients to liquids under moderate
agitation.
3. Heat mixture to 190 F. with constant stirring. Hold at 190 F. for
10 minutes.
4. Cover and cool.

TABLE 11

| | Control (Dairy Fat) | Control TAG | DAG |
|---|---|---|---|
| White Cream Sauce | % | % | % |
| National 465 | 2.50 | 2.50 | 2.50 |
| Modified Food Starch | | | |
| Butter Buds (8x) | 1.54 | 1.54 | 1.54 |
| Salt | 0.50 | 0.50 | 0.50 |
| All Purpose Flour | 0.30 | 0.30 | 0.30 |
| Sweet Whey | 0.20 | 0.20 | 0.20 |
| Celery Salt | 0.05 | 0.05 | 0.05 |
| Ground White Pepper | 0.03 | 0.03 | 0.03 |
| Onion Powder | 0.01 | 0.01 | 0.01 |
| ADM Xanthan Gum | 0.06 | 0.06 | 0.06 |
| SSL | 0 or 0.20 | 0 or 0.20 | 0 or 0.20 |
| Nonfat Dry Milk | 8.50 | 8.50 | 8.50 |
| (NFDM) | | | |
| Butter | 7.30 | — | — |
| Oil | — | 7.30 | 7.30 |
| Water | 78.77-78.97 | 78.77-78.97 | 78.77-78.97 |
| Total: | 100.00 | 100.00 | 100.00 |

Procedure:
1. Combine and pre-blend dry ingredients.
2. Combine water and oil/butter. Add dry ingredients to liquids under
moderate agitation.
3. Heat mixture to 190 F. with constant stirring. Hold at 190 F. for
10 minutes.
4. Cover and cool.

TABLE 12

| | Control | | |
|---|---|---|---|
| | (Veg. | | |
| | Shortening) | Control (TAG) | DAG |
| Brown Gravy | % | % | % |
| Purity W Modified Food | 3.50 | 3.50 | 3.50 |
| Starch (National) | | | |
| Hydrolyzed Vegetable | 1.23 | 1.23 | 1.23 |
| Protein | | | |
| Paprika | 0.25 | 0.25 | 0.25 |
| Onion Powder | 0.20 | 0.20 | 0.20 |
| Salt | 0.10 | 0.10 | 0.10 |
| Caramel Color | 0.10 | 0.10 | 0.10 |
| Garlic Powder | 0.05 | 0.05 | 0.05 |
| Ground Black Pepper | 0.05 | 0.05 | 0.05 |
| Canned Beef Stock | 62.95 | 62.95 | 62.95 |
| ADM Xanthan Gum | — | 0.17 | 0.17 |
| Water | 25.23 | 25.23 | 25.23 |
| Worchestershire Sauce | 0.25 | 0.25 | 0.25 |
| Vegetable Shortening | 6.09 | — | — |
| 70% Soybean/ | — | 6.09 | — |
| 30% Canola Oil | | | |
| DAG Oil | — | — | 6.09 |
| Total: | 100.00 | 100.00 | 100.00 |

Procedure:
1. Combine canned beef stock, water and worchestershire sauce in a
cooking vessel.
2. Dry blend starch, spices and xanthan gum (if necessary). Add to
liquids under moderate agitation.
3. Heat mixture to 190 F. Hold at 190 F. for 10 minutes.
4. Remove from heat and stir in shortening. Cover and cool.

TABLE 13

| Barbecue Sauce | % |
|---|---|
| Water | 35.00 |
| White Vinegar (5% Acidity) | 15.00 |
| Tomato Paste | 20.00 |
| Brown Sugar | 17.00 |
| Oil | 5.00 |
| Pure-Flo Modified Food Starch | 2.00 |
| Salt | 2.00 |
| Worchestershire Sauce | 1.00 |
| Onion Powder | 0.75 |
| Garlic Powder | 0.75 |
| Paprika | 0.75 |
| Ground Red Pepper | 0.25 |
| Allspice | 0.25 |
| Ground White Pepper | 0.25 |
| Total: | 100.00 |

Procedure:
1. Disperse starch into water.
2. Add remaining ingredients to the starch and water mixture. Blend
well.
3. Heat to 190 F. using an agitator and hot plate. Hold for 10 minutes at
190 F.
4. Cover and cool.

Honey Mustard Marinade

This formula was obtained from the internet at www-2.cs.cmu.edu. Xanthan gum was added to provide thickening; water was used as a hydration media. Modification using xanthan gum allowed formulation to be used as a marinade/rub in freeze/thaw applications; formula without xanthan gum would be used for grilling/marinating meats.

TABLE 14

| Honey Mustard Marinade | % |
|---|---|
| Dijon Mustard | 28.15 |
| Dry White Wine | 27.02 |
| Oil | 18.58 |
| Honey | 14.86 |
| Minced Garlic | 0.09 |
| Soy Sauce | 4.05 |
| Water | 7.05 |
| ADM Xanthan Gum, 80 mesh | 0.20 |
| Total: | 100.00 |

Procedures:
1. Hydrate the xanthan gum in water using moderate agitation for
5-10 minutes.
2. Add remaining ingredients and mix well.

Results (White Cream Sauce Using Milk and Cream as Model System):

For viscosity profiles at 22 C:

White sauce made with DAG is notably more viscous than white sauce made with TAG over the entire shear range.

White sauce made with DAG is comparable to milk/cream white sauce at low shear rates but is notably more viscous than milk/cream white sauce at high shear rates.

White sauce made with TAG is notably less viscous than milk/cream white sauce at low shear rates but notably more viscous than milk/cream white sauce at high shear rates.

For viscosity profiles at 50 C:

White sauce made with DAG is notably more viscous than either white sauce made with TAG or milk/cream white sauce over entire viscosity range.

White sauce made with TAG is comparable to the milk/cream white sauce at low shear rates but is notably more viscous than milk/cream white sauce at high shear rates.

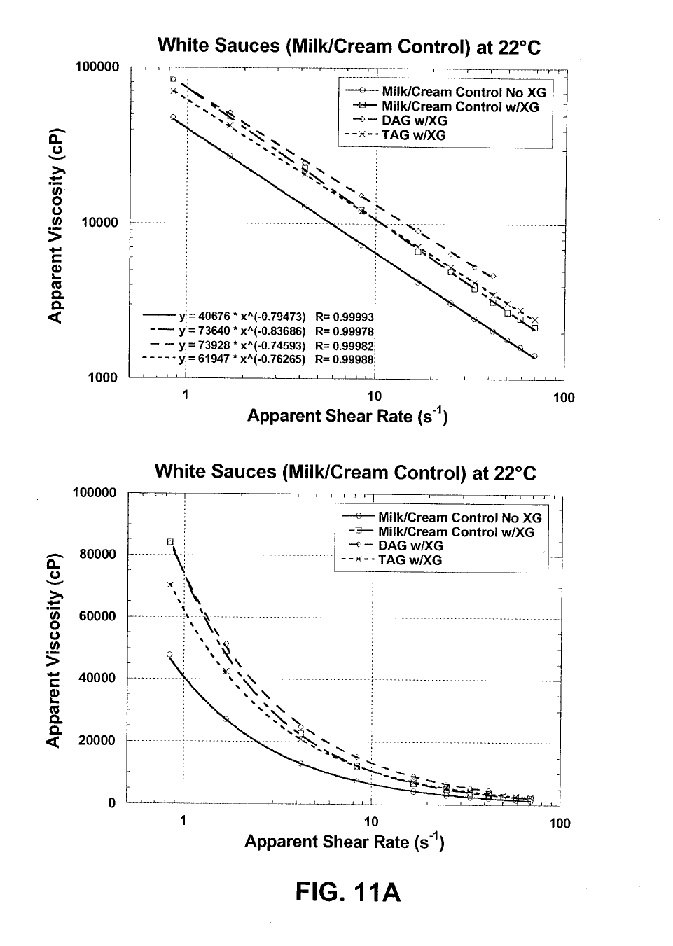

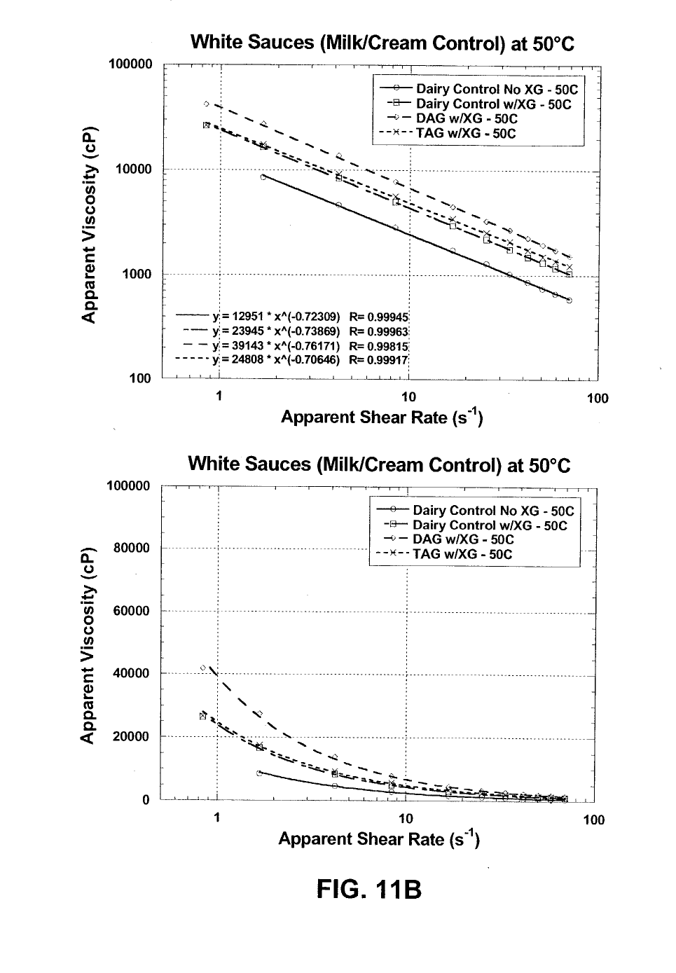

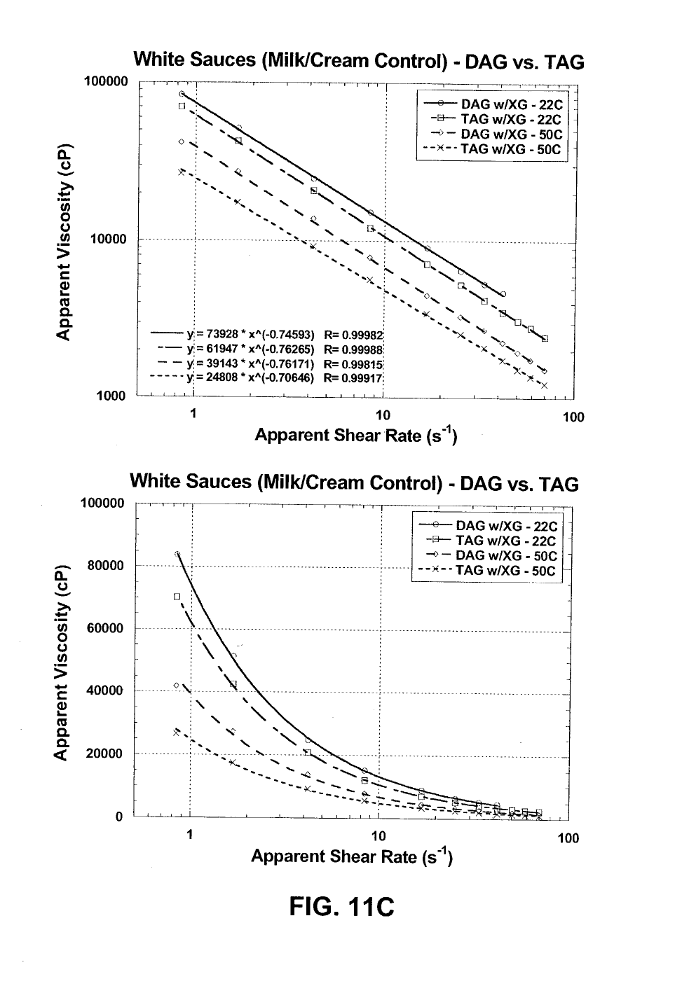

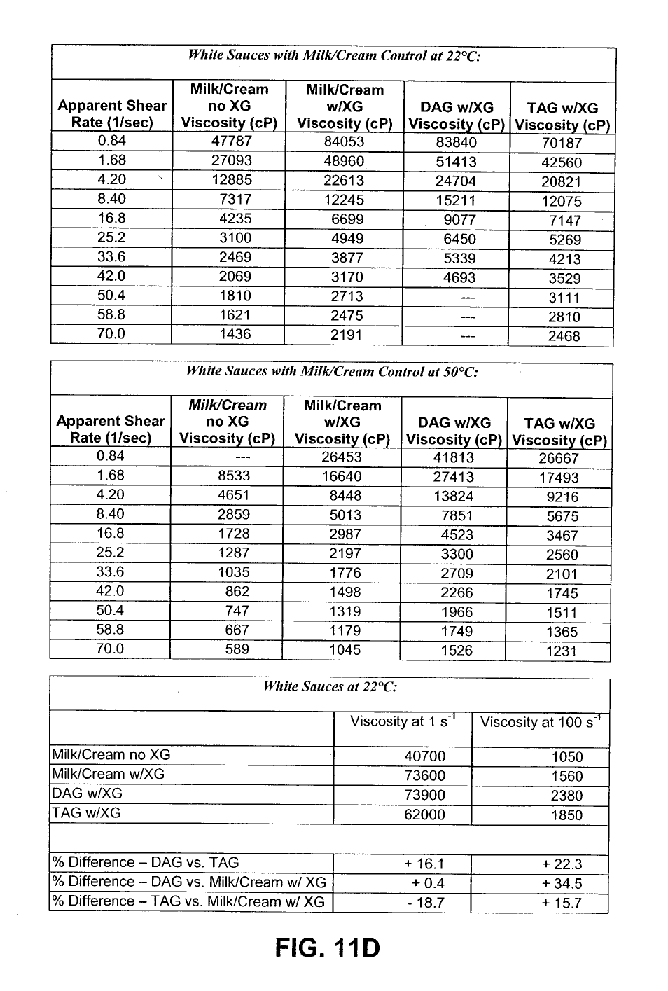

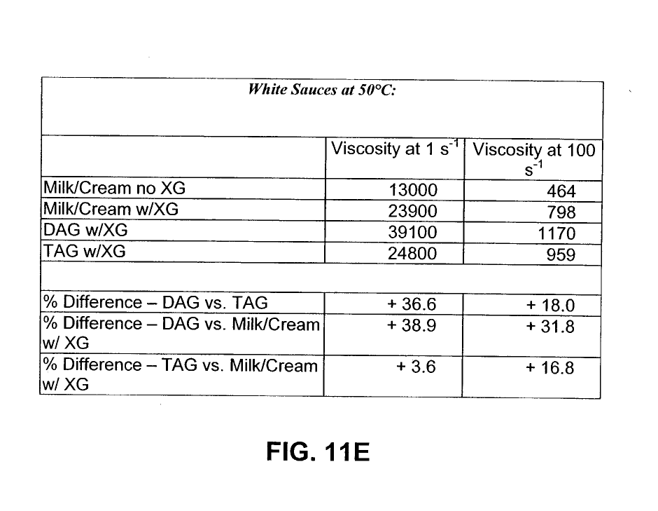

Since 50° C. simulates consumption temperature of the sauce, results indicate using DAG or TAG to replace milk and cream in a white sauce will produce an acceptable sauce with respect to viscosity and mouthfeel. In fact, the white sauce made with DAG would be perceived as thicker and creamier than either the milk/cream white sauce or TAG white sauce, possibly increasing consumer acceptability of the product See FIGS. 11A-11E.

By utilizing emulsifiers and hydrocolloids, the formulation made with DAG had similar viscosity and mouthfeel to the dairy fat control made with light cream and whole milk. However, the product made with TAG oil, emulsifier, and hydrocolloids was considerably less viscous, mouthfeel was less creamy, and the flavor profile was more spiky/less blended than either the DAG oil or dairy formulations.

Changes in viscosity and mouthfeel between DAG and TAG formulations may be due to improved emulsification efficiency seen in DAG vs. TAG. Since DAG is more polar and has lower interfacial tension than TAG, it can form smaller oil droplets within the food, yielding improved emulsion stability and a smoother, creamier mouthfeel in the finished product. Differences in flavor profile between DAG and TAG formulations may be due to differences in partitioning behavior of flavor volatiles resulting from the difference in polarity between the two oils. This phenomena has been observed in other applications utilizing DAG oil, mainly in oil-in-water (O/W) emulsions, but not limited to O/W emulsions.

Results (White Cream Sauce Using NFDM and Butter as Model System)

White Sauce—22° C.—No SSL:

No difference in viscosity was observed between white sauces made with DAG or TAG.

White sauces made with oil (either DAG or TAG) were notably less viscous over the entire shear range than the white sauce made with NFDM and butter. Reduction in viscosity of DAG and TAG oils versus butter was comparable for both DAG and TAG treatments.

White Sauce—22° C.—with 0.2% SSL:

The white sauce made with DAG was slightly higher in viscosity than the white sauce made with TAG at low shear rates, but was within an acceptable range of variation at high shear rates.

Sauces made with both DAG and TAG oils were notably less viscous than the white sauce made with butter. Larger differences in viscosity were observed between TAG and butter than between DAG and butter, indicating that viscosity of DAG is less impacted by addition of emulsifiers than TAG is in this application.

White Sauce—50° C.—No SSL:

No differences in viscosity were observed between the white sauces made with DAG or TAG over the entire shear range.

White sauces made with oil (either DAG or TAG) were notably less viscous over most of the shear range tested than the white sauce made with NFDM and butter. Reduction in viscosity of DAG and TAG oils versus butter was comparable for both DAG and TAG treatments.

White Sauce—50° C.—with 0.2% SSL:

The white sauce made with DAG is notably thicker over the entire shear range than the white sauce made with TAG.

Sauces made with both DAG and TAG oils were notably less viscous than the white sauce made with butter. Larger differences in viscosity were observed between TAG and butter than between DAG and butter, indicating that viscosity of DAG is less impacted by addition of emulsifiers than TAG is in this application.

Additional conclusions/observations:

Formulation of white sauces with DAG or TAG oils were more comparable to the butter control when no emulsifiers were used.

When emulsifiers were used in the formulation, viscosity readings taken at 22° C. showed a decrease in low shear in all treatments tested; viscosity at high shear was unchanged in formulations made with butter, but decreased in formulations made with DAG or TAG oil.

When emulsifiers were used in the formulation, viscosity readings taken at 50° C. were unchanged in formulations made with butter, decreased at low shear in both DAG and TAG oil treatments, were unchanged at high shear in the formula made with DAG, and decreased in the formula made with TAG.

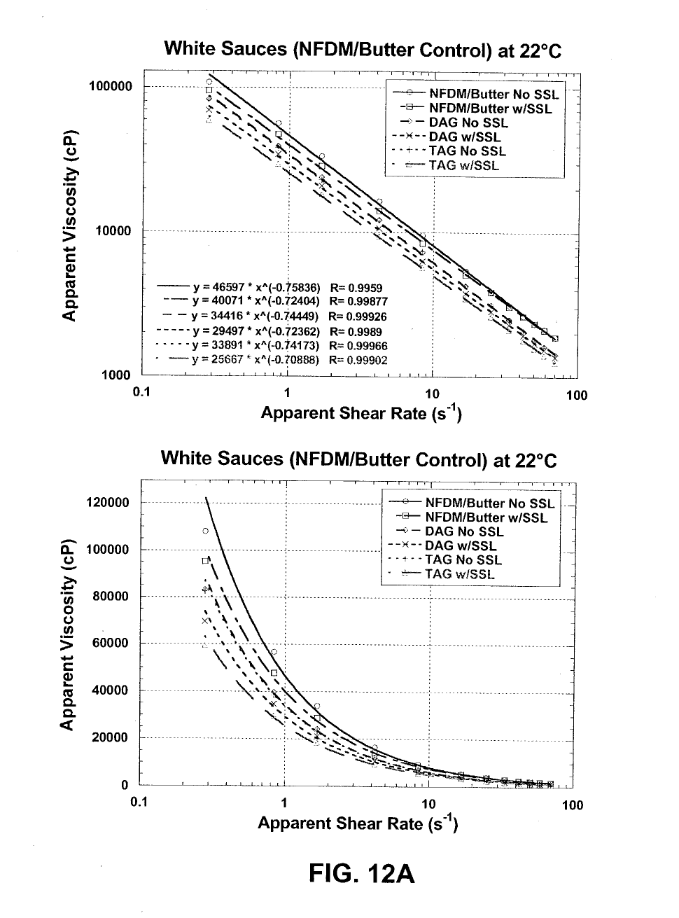

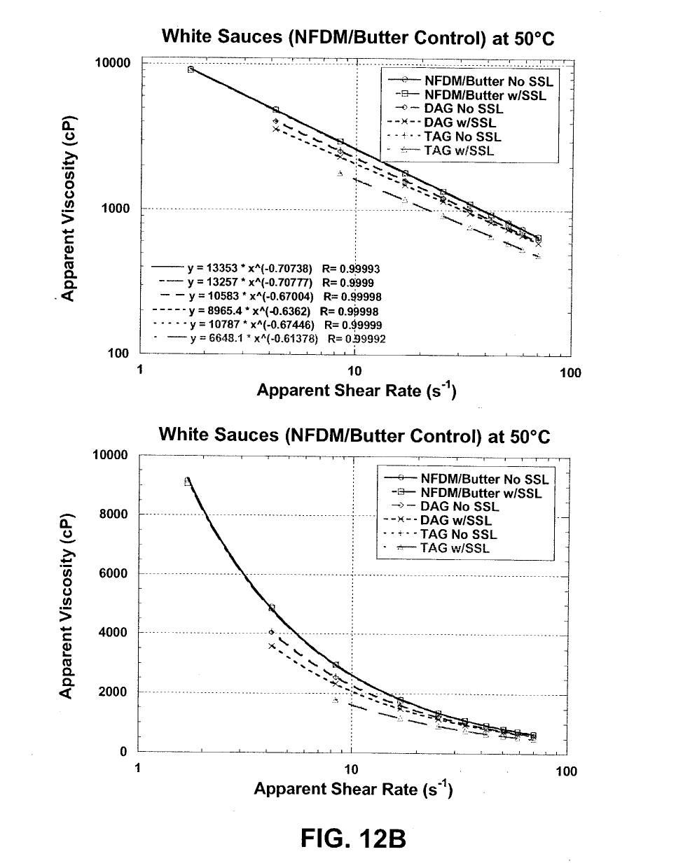

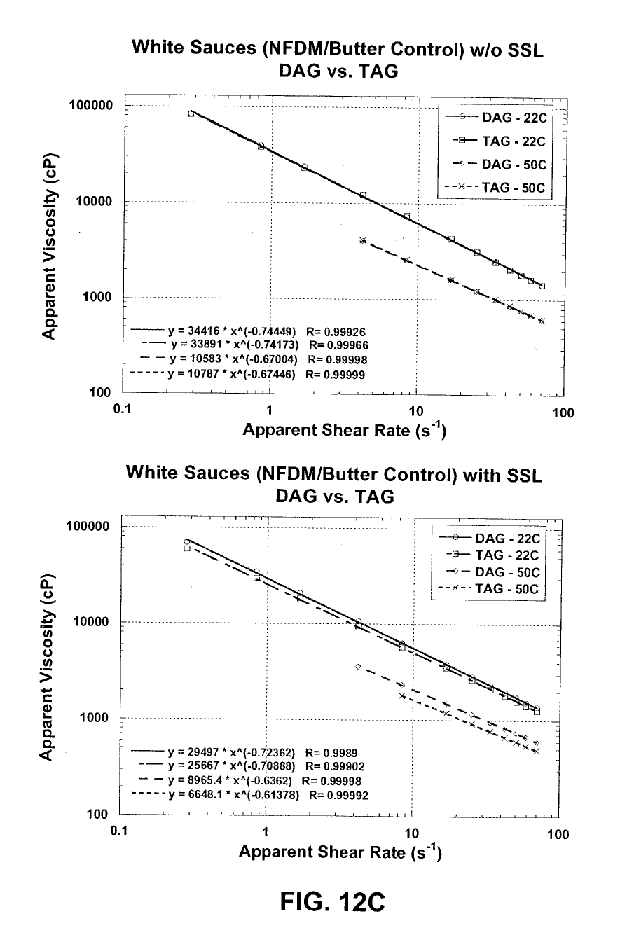

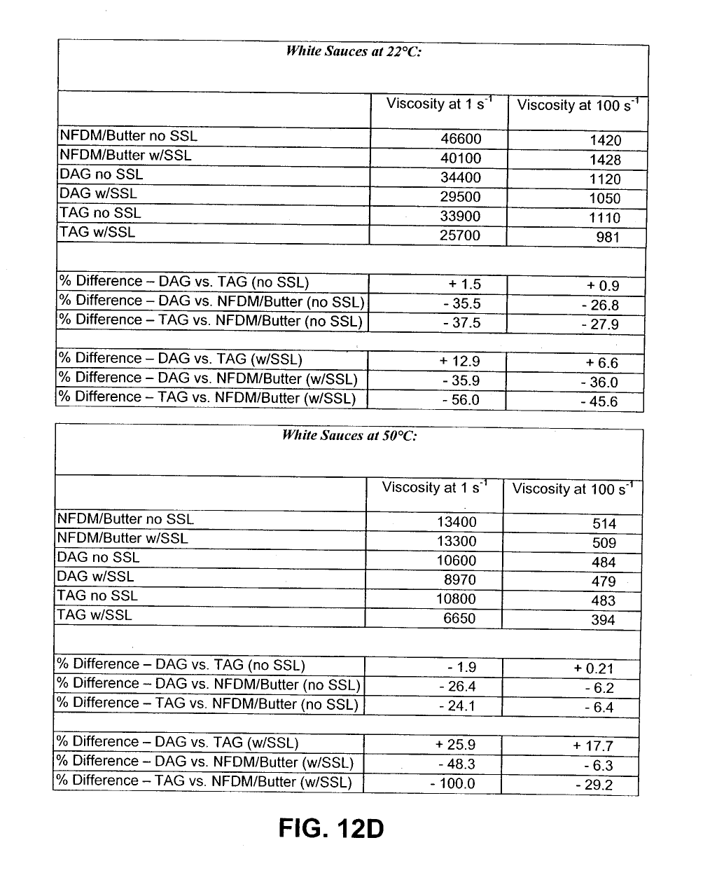

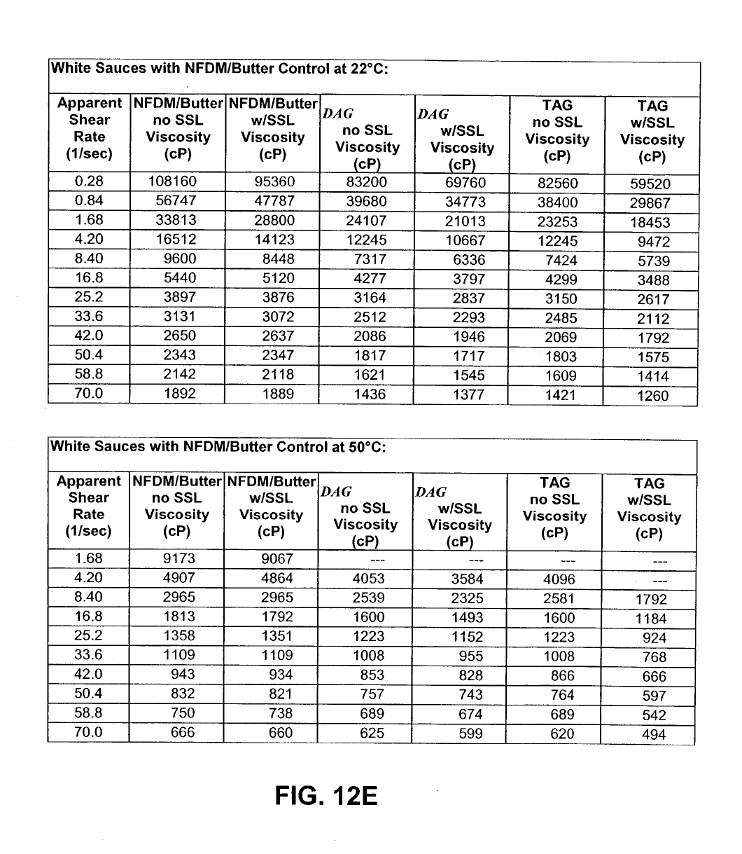

If emulsifiers are used in combination with oils to make a white sauce, fewer formulation modifications would be necessary to approximate the viscosity of butter when DAG oil is used in place of TAG oil. See FIGS. 12A-12E.

Results (Brown Gravy):

No notable differences between formulations made with DAG or TAG were observed.

Viscosities were within the acceptable range of variation for DAG, TAG, and PHSBO (partially hydrogenated soybean oil)+xanthan gum (XG) formulas at 22° C.

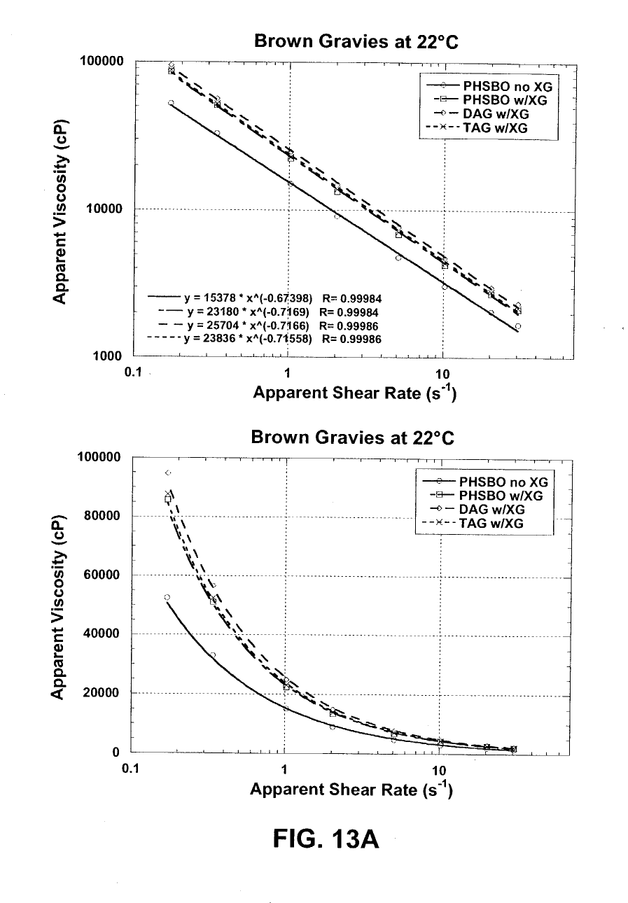

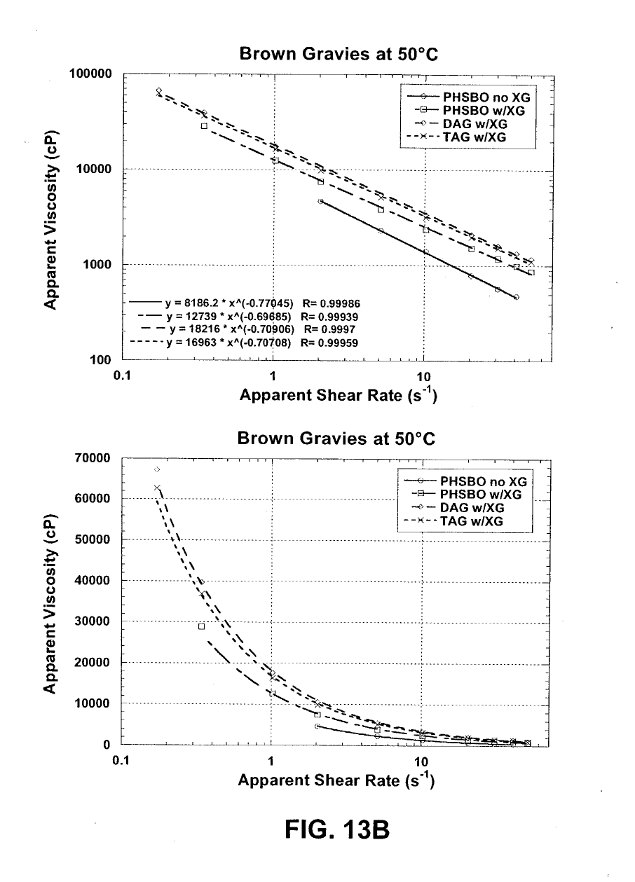

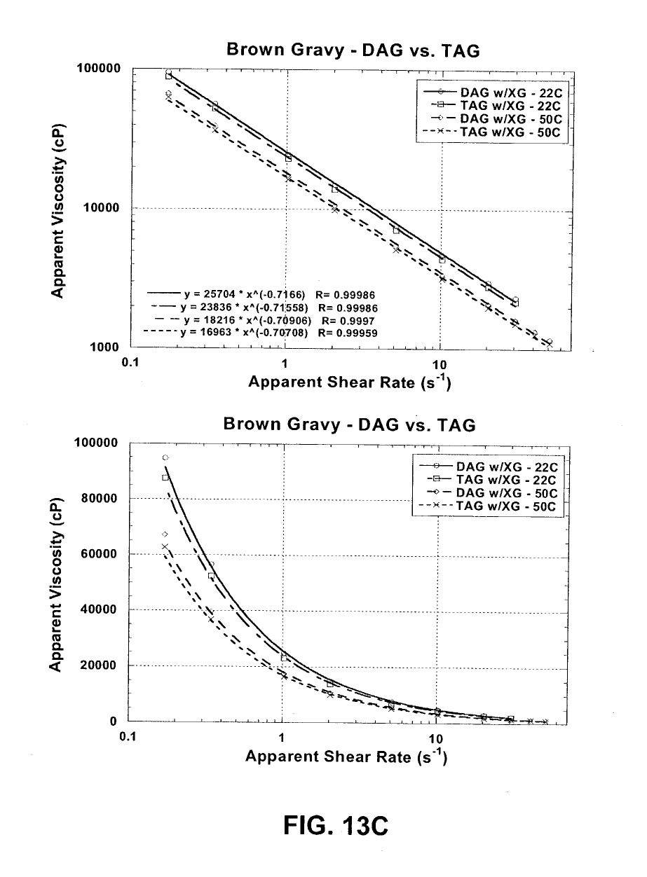

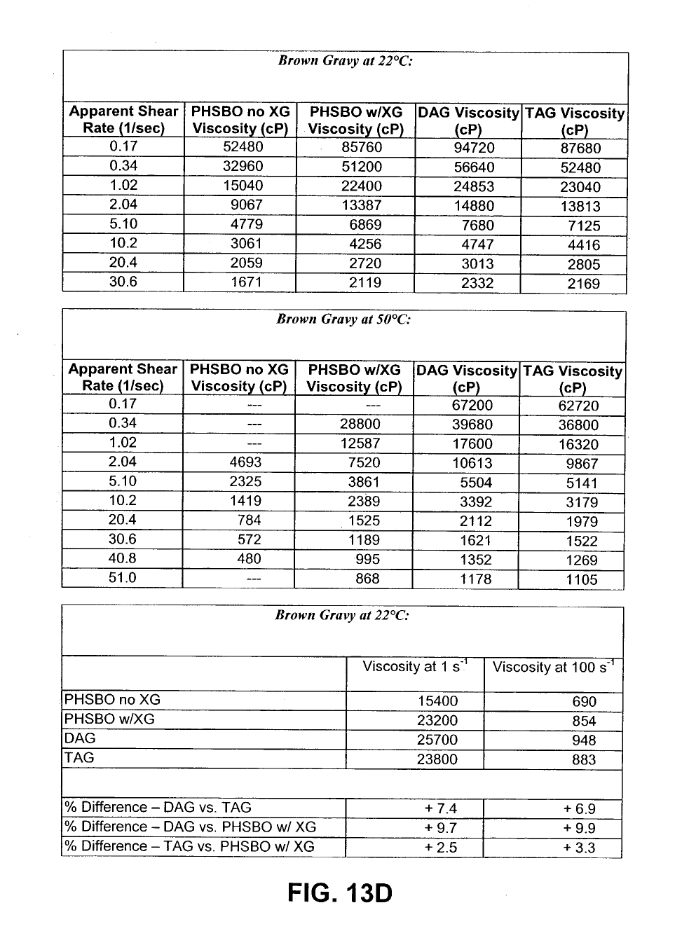

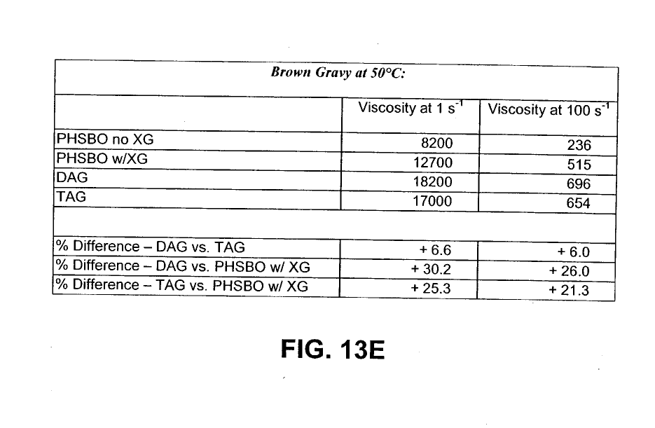

Viscosity readings of DAG vs. TAG at 50° C. were within acceptable ranges of variation; viscosity of DAG and TAG were notably larger than viscosity of PHSBO at 50° C. Difference in viscosity at 50° C. was most likely due to melting of solid fat and subsequent reduction in viscosity for the PHSBO treatment. See FIGS. 13A-13E.

By utilizing hydrocolloids for improved stability and thickening upon cooling, the formulation made with DAG oil had similar viscosity and mouthfeel to the partially hydrogenated soybean oil control. However, the product made with TAG oil and hydrocolloids was less viscous and the mouthfeel was less creamy than either the DAG oil or vegetable shortening formulations.

Changes in viscosity and mouthfeel between DAG and TAG formulations may be due to improved emulsification efficiency seen in DAG vs. TAG. Since DAG is more polar and has lower interfacial tension than TAG, it can form smaller oil droplets within the food, yielding improved emulsion stability and a smoother, creamier mouthfeel in the finished product.

Another notable observation included the fact that, upon cooling, gravy made with DAG or TAG oil was more homogeneous than the gravy made with vegetable shortening. This was most likely due to the difference in level of saturates/higher melt point in shortening relative to oil.

Results (Barbeque and Marinades):

Barbecue Sauce:

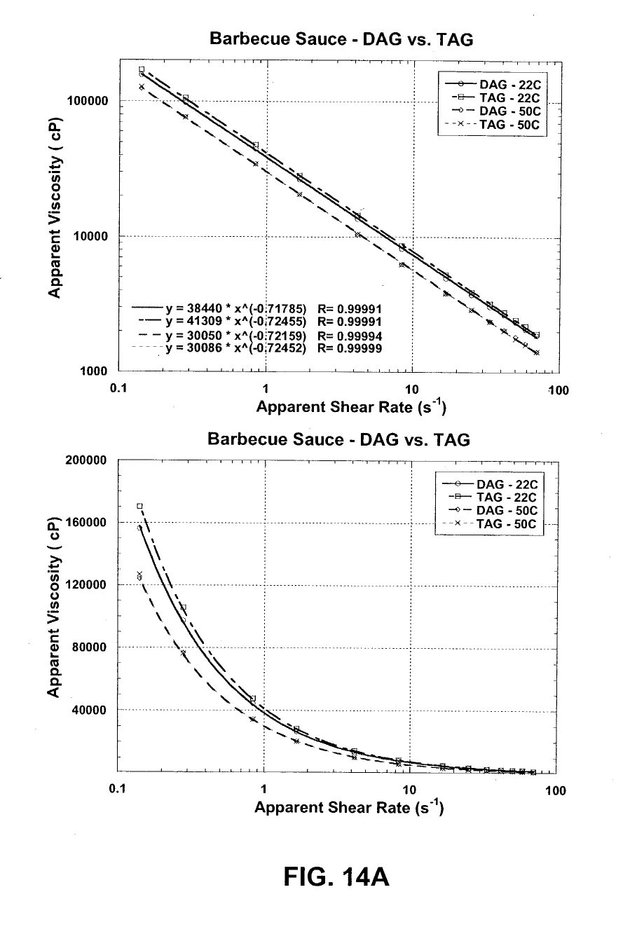

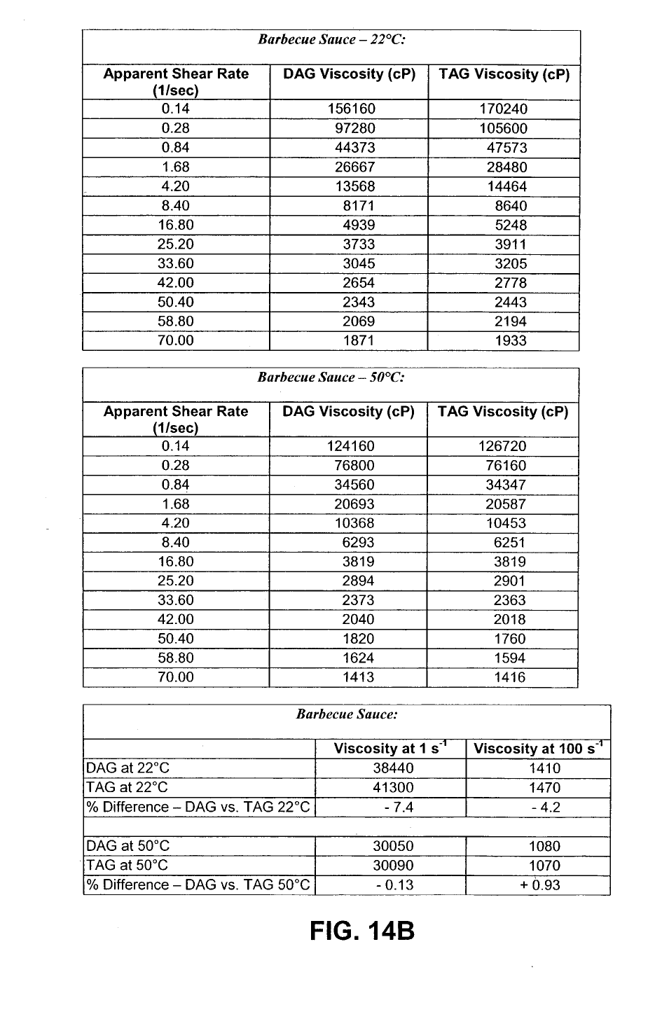

No notable differences between formulations made with DAG or TAG. Viscosities were within the acceptable range of variation for DAG and TAG formulas See FIGS. 14A-14B.

Formulations made with diacylglycerol oil had slightly less vinegar bite (BBQ and marinade) and heat/burn from the mixture of red and black pepper used in the formulation (BBQ sauce). Flavor profile was less spiky/more blended in formulations made with diacylglycerol oil. No major differences were observed in viscosity between formulations made with DAG or TAG oil, indicating that DAG could be used as a one-for-one replacement for TAG in these applications.

Differences in flavor profile between DAG and TAG formulations may be due to differences in partitioning behavior of flavor volatiles resulting from the difference in polarity between the two oils. This phenomena has been observed in other applications utilizing DAG oil, mainly in oil-in-water (O/W) emulsions, but not limited to O/W emulsions.

Overall Conclusions for Above-Mentioned Applications and Results:

Depending on the application, use of diacylglycerol oil may allow either a partial or complete substitution of animal/vegetable fats present in the formula.

Substituting animal/vegetable fats with diacylglycerol oil will reduce the consumption of saturated fats and increase the level of consumption of monounsaturated and polyunsaturated fats, further increasing the “healthfulness” of the food product/entree

Substituting diacylglycerol oil for the animal/vegetable fats used in the above-mentioned model systems did not compromise the quality or flavor profile of these products.

### Example 5

Materials and Methods—Soy Protein-Fortified Caramel with Diacylglycerol Oil for End-Use in Nutritional/Power/Snack Bar.

Materials:

Caramel formulation containing 13.38% soy isolate used for both treatments. The treatments differed only in oil type.

Oils Tested:

Control: 70/30 Soybean oil/Canola oil mixture

Test 1: Enova oil from ADM plant

Procedure/Results:

Both caramel treatments were made by an established bench-top procedure using Bottomline Technologies heating unit with heavy-duty agitator. After each treatment was thoroughly cooled to room temperature, bench-top evaluation of the caramel treatments was conducted. Bench-top evaluation indicated that the caramel made with diacylglycerol oil had a more dairy-like, creamy flavor than the caramel made with triacylglycerol oil. Twenty-four hours after make-up, textural differences between the two treatments were observed. The caramel made with diacylglycerol oil seemed to have a firmer texture than the caramel made with triacylglycerol oil. Texture and moisture analyses were conducted. The caramel made with diacylglycerol oil exhibited a greater maximum force (2.27±0.16 kg) than the caramel made with triacylglycerol oil (1.18±0.17 kg); however, the DAG caramel had a lower percent moisture (7.42±0.49%) than the TAG caramel (9.73±0.24%). The moisture differences are likely due to slight differences in heating from one treatment to another and not necessarily due to the differences in fat source.

Discussion:

The “creamier” mouthfeel noted in the caramel made with diacylglycerol oil may be due to the emulsification properties of the diacylglycerol oil. No other emulsifier was added to the treatment formulaions. Also, the caramel made with DAG oil was noticeably lighter in color than the caramel made with TAG oil. Differences in color may also be due to the emulsification properties of the DAG oil. In the application of the soy-enhanced caramel, using diacylglycerol oil in place of triacylglycerol oil appears to be advantageous, as it improves flavor and mouthfeel, presumably by its emulsification characteristics.

The textural differences between the DAG and TAG caramels are likely a compounded effect between the moisture and fat source differences. In any case, using DAG oil in place of TAG oil in the soy-enhanced caramel application should not cause a detrimental effect on texture. A caramel with a firmer texture, such as that observed with the DAG caramel, may be desirable in a coated nutrition bar. Caramels in which the viscosity is too low can cause undesirable leakages in small holes and crevices of a milk chocolate or confectionery coating. However, if a softer, less viscous caramel is desired, changes in the formulation can be made, such as increasing the moisture, to obtain the less-viscous characteristic.

TABLE 15

| High Protein Caramel | % |
|---|---|
| Protein Paste: | |
| ADM Pro-Fam 825 Soy Protein Isolate | 13.38 |
| ADM Cornsweet55 HFCS | 13.39 |
| Water | 13.78 |
| Caramel Base: | |
| Sucrose | 21.17 |
| Methocel K-100 (Dow) | 0.37 |
| Water | 3.53 |
| ADM Cornsweet55 HFCS | 7.06 |
| ADM 42/43 Corn Syrup 42 DE | 7.06 |
| Vanilla Extract | 0.28 |
| Evaporated Milk | 11.99 |
| Condensed Milk Flavor | 0.13 |
| Oil | 6.70 |
| Brown Sugar Flavor | 0.16 |
| Butter Flavor | 0.04 |
| Masking Flavor | 0.28 |
| Salt | 0.70 |
| Total: | 100.00 |

```
Procedure: This procedure requires a Bottomline Technologies heating unit
with a heavy-duty agitator for a 1500 gram batch.
  1. Turn on heating unit. Set temperature to 400° F.
  2. To start caramel base, add water, corns syrup, HFCS, sucrose,
  Methocel and salt.
  3. Turn on agitator to 40% capacity.
  4. Once corn syrup mixture reaches homogeneous consistency, slowly
  add oil.
  5. Once oil is thoroughly incorporated, add evaporated milk.
  6. Allow agitation to continue until temperature reaches 235° F.
  7. Meanwhile, heat HFCS and water for protein paste to 120° F.
  8. In bench-top mixer (Kitchen-Aid or Hobart), slowly add Pro-Fam 825
  soy isolate to HFCS solution while continuously agitating with
  paddle. Continue until all soy isolate is added and paste is homo-
  geneous.
  9. Once caramel base has reached 235° F., start adding small amounts
  of protein paste to base and increase agitation to 70% capacity.
10. Continue until all the paste is added to the base; allow temperature to
  return to 210° F.
11. Add powdered/liquid flavors; once temperature has reached 220° F.,
  remove pan from heating unit.
12. Spread soy caramel in pan and allow to cool.
```

Moisture Method

1. Two samples of each caramel treatment were weighed in 1 g foil pans in approximately 2 g increments.

2. The samples were placed in a vacuum oven at 75° F. at −25 inches Hg for 24 hours.

3. The samples were weighed after 24 hours and the resulting loss in weight was calculated as percent moisture.

Texture Analysis Method

1. Texture Technologies TA-XT-plus instrument with 12 mm diameter plastic cylinder probe was used.

2. 20±0.5 g samples were formed into cubes with the following dimensions: 2.5 cm×2.5 cm×2.0 cm (width x length x height).

3. Each sample was placed on a platform for measurement to prevent texture softening from the heat of the instrument.

4. Five samples of each treatment were evaluated by mode of compression using the settings listed below.

Pre-test speed—2.0 mm/sec

Test speed—5.0 m/sec

Post-test speed—5.0 mm/sec

Distance—5.0 mm

Trigger Froce—5 g (Auto)

Break Mode—Off

Stop Plot at Start Position

Tare Mode—Auto

### Example 6

Spoonable Salad Dressing

The following formulation demonstrates the use of diacylglycerol oil in a spoonable salad dressing. Because of the high percentage of oil in these products (up to 85% total formula weight) and the difference in polarity between DAG and TAG, formulation of a mayonnaise using traditional emulsifiers and manufacturing processes is difficult. To make a mayonnaise product which will be stable over typical storage and use conditions, it is necessary to replace the unmodified egg yolk traditionally used with enzyme modified egg yolks. Enzyme modified egg yolks are more polar than their traditional counterparts, and thus more functional in this particular application. Because spoonable dressing and mayonnaise are similar emulsion types (though oil levels in spoonable dressings typically range from 30-50% as opposed to 65-85% total formula weight for mayonnaise), it would be assumed that enzyme modified egg yolk would also be necessary in order to provide a stable emulsion in this system. However, through practice of the above-mentioned formula, it was discovered that use of enzyme modified yolks was not necessary to achieve a stable emulsion in spoonable dressings. Ability to use traditional ingredients and processing conditions in this product enables the formulator to have greater flexibility and a more economical way to create a healthier product for consumer use.

Formulation for Spoonable Salad Dressing

TABLE 16

| STARCH PASTE: | % |
|---|---|
| Water | 93.5 |
| Modified food starch | 5.0 |
| ADM 80 mesh Xanthan Gum | 0.5 |

Combine starch and xanthan gum, and add to water with high shear. Stir and allow to hydrate approximately 5 minutes. Heat mixture to 90° C. while stirring constantly. Cool to 30° C. or less, stirring constantly.

TABLE 17

| SALAD DRESSING: | % |
|---|---|
| Starch paste from above | 42.36 |
| Enova Oil | 33.33 |
| Sugar | 9.00 |
| Vinegar (100 grain) | 7.50 |
| Egg yolk | 5.00 |
| Salt | 2.00 |
| Mustard Powder | 0.45 |
| Paprika | 0.25 |
| Lemon Juice | 0.10 |
| EDTA | 0.01 |
| Total: | 100.00 |

Procedure:
1. Place starch paste in a Hobart bowl fitted with a wire wisk. Add egg
yolks and blend at medium speed until well mixed.
2. Add mustard powder, sugar, salt and EDTA and blend well.
3. Slowly add oil (slow drizzle) while continuing to mix.
4. Add vinegar and lemon juice and mix well.
5. Process using a colloid mill set at an appropriate gap.
6. Package.

All patents, applications, and publications referred to herein are expressly incorporated by reference in their entirety.

What is claimed is:

1. A food product comprising diacylglycerol oil wherein the diacylglycerol oil is used in place of some or all of a triacylglycerol oil/fat.

2. The food product of claim 1 wherein the food product is selected from the group consisting of salad dressings, coffee whiteners, nutritional drinks or beverages, sauces, gravies, marinades, rubs, nutritional bars, baked goods, caramel, confections, and yogurt.

3. The food product of claim 2 which is a salad dressing.

4. The food product of claim 3 wherein said salad dressing is a spoonable salad dressing.

5. The food product of claim 4 wherein said spoonable salad dressing does not contain enzyme-modified egg yolks.

6. The food product of claim 3 wherein said salad dressing is a pourable salad dressing.

7. The food product of claim 2 which is a coffee whitener.

8. The food product of claim 2 which is a nutritional drink or beverage.

9. The food product of claim 8 wherein the nutritional drink or beverage is a soy-based milk.

10. The food product of claim 9 further comprising additional flavor components.

11. The food product of claim 2 which is a sauce.

12. The food product of claim 2 which is a gravy.

13. The food product of claim 2 which is a marinade.

14. The food product of claim 2 which is a rub.

15. The food product of claim 2 which is a nutritional bar.

16. The food product of claim 2 which is a baked good.

17. The food product of claim 2 which is a caramel.

18. The food product of claim 17 wherein the caramel is soy protein-fortified.

19. The food product of claim 2 which is a confection.

20. The food product of claim 2 which is yogurt.

21. The food product of claim 1 wherein said diacylglycerol oil comprises 1,3-diglycerides in an amount from about 40% to about 100% by weight.

22. The food product of claim 21 wherein the diacylglycerol oil comprises 1,3-diglycerides in an amount of at least about 45% by weight.

23. The food product of claim 22 wherein the diacylglycerol oil comprises 1,3-diglycerides in an amount of at least about 50% by weight.

24. The food product of claim 21 wherein unsaturated fatty acids account for about 50% to about 100% by weight of the fatty acid components constituting the 1,3-diglycerides.

25. The food product of claim 24 wherein unsaturated fatty acids account for at least about 93% by weight of the fatty acid components constituting the 1,3-diglycerides.

26. The food product of claim 25 wherein unsaturated fatty acids account for at least about 95% by weight of the fatty acid components constituting the 1,3-diglycerides.

27. The food product of claim 1 wherein diacylglycerol oil and triacylglycerol oil/fat are present in a ratio of from about 1:100 to about 100:0 diacylglycerol oil to triacylglycerol oil/fat.

28. A food product comprising a diacylglycerol oil-in-water emulsion wherein diacylglycerol oil is used in place of some or all of a triacylglycerol oil/fat.

29. The food product of claim 28 wherein said diacylglycerol oil-in-water emulsion comprises an emulsifier.

30. The food product of claim 29 wherein the emulsifier is selected from the group consisting of standard lecithin, acetylated lecithin, hydroxylated lecithin, modified lecithin, sodium stearoyl lactate, and sodium stearoyl lactate in combination with distilled monoglycerides, monodiglycerides, ethoxylated monoglycerides, monodiglycerides, polysorbates, polyglycerol esters, PGPR, sucrose esters, succinylated monoglycerides, acetylated monoglycerides, lactylated monoglycerides, sorbitan esters, DATEMs, soy protein isolate/concentrate/flour, whey protein isolate/concentrate, sodium caseinate, and calcium caseinate.

31. The food product of claim 30 wherein the emulsifier is standard lecithin.

32. The food product of claim 30 wherein the emulsifier is sodium stearoyl lactate.

33. The food product of claim 28 wherein the food product is selected from the group consisting of salad dressings, coffee whiteners, nutritional drinks or beverages, sauces, gravies, marinades, rubs, nutritional bars, baked goods, caramel, confections, and yogurt.

34. The food product of claim 33 which is a salad dressing.

35. The food product of claim 34 wherein said salad dressing is a spoonable salad dressing.

36. The food product of claim 35 wherein said spoonable salad dresssing does not contain enzyme-modified egg yolks.

37. The food product of claim 34 wherein said salad dressing is a pourable salad dressing.

38. The food product of claim 33 which is a coffee whitener.

39. The food product of claim 33 which is a nutritional drink or beverage.

40. The food product of claim 39 wherein the nutritional drink or beverage is a soy-based milk.

41. The food product of claim 40 further comprising additional flavor components.

42. The food product of claim 33 which is a sauce.

43. The food product of claim 33 which is a gravy.

44. The food product of claim 33 which is a marinade.

45. The food product of claim 33 which is a rub.

46. The food product of claim 33 which is a nutritional bar.

47. The food product of claim 33 which is a baked good.

48. The food product of claim 33 which is a caramel.

49. The food product of claim 48 wherein the caramel is soy protein-fortified.

50. The food product of claim 33 which is a confection.

51. The food product of claim 33 which is yogurt.

52. The food product of claim 28 wherein said diacylglycerol oil comprises 1,3-diglycerides in an amount from about 40% to about 100% by weight.

53. The food product of claim 52 wherein the diacylglycerol oil comprises 1,3-diglycerides in an amount of at least about 45% by weight.

54. The food product of claim 53 wherein the diacylglycerol oil comprises 1,3-diglycerides in an amount of at least about 50% by weight.

55. The food product of claim 52 wherein unsaturated fatty acids account for about 50% to about 100% by weight of the fatty acid components constituting the 1,3-diglycerides.

56. The food product of claim 55 wherein unsaturated fatty acids account for at least about 93% by weight of the fatty acid components constituting the 1,3-diglycerides.

57. The food product of claim 56 wherein unsaturated fatty acids account for at least about 95% by weight of the fatty acid components constituting the 1,3-diglycerides.

58. The food product of claim 28 wherein diacylglycerol oil and triacylglycerol oil/fat are present in a ratio of from about 1:100 to about 100:0 diacylglycerol oil to triacylglycerol oil/fat.
